(19) United States
(12) Patent Application Publication
(10) Pub. No.: US 2011/0223522 A1
(43) Pub. Date: Sep. 15, 2011

(54) BIPOLAR PLATE FOR FUEL CELL, METHOD OF MANUFACTURING THE BIPOLAR PLATE, AND FUEL CELL INCLUDING THE BIPOLAR PLATE

(75) Inventors: Ji-rae KIM, Seoul (KR); Jung-seok Yi, Seoul (KR); Tae-won Song, Yongin-si (KR); Kyoung-hwan Choi, Suwon-si (KR)

(73) Assignee: Samsung Electronics Co., Ltd., Suwon-si (KR)

(21) Appl. No.: 12/957,561

(22) Filed: Dec. 1, 2010

(30) Foreign Application Priority Data
Mar. 12, 2010 (KR) 10-2010-0022426

(51) Int. Cl. H01M 4/60; H01M 4/04; H01M 8/00

(52) U.S. Cl. 429/518; 427/115

(57) ABSTRACT

A bipolar plate for a fuel cell includes a metal plate and a coating layer disposed on a surface of the metal plate. The coating layer includes a polymer of an oxazine-based compound, particularly, a benzoxazine-based compound and a conducting material. A method of manufacturing the bipolar plate includes coating a surface of a metal plate with a coating layer forming composition including at least one oxazine-based compound, a conducting material, and a solvent; and thermally treating the metal plate coated with the coating layer forming composition. A fuel cell includes the bipolar plate.

### CROSS-REFERENCE TO RELATED APPLICATION

This application claims the benefit of Korean Patent Application No. 10-2010-0022426, filed on Mar. 12, 2010, in the Korean Intellectual Property Office, the disclosure of which is incorporated herein in its entirety by reference.

### BACKGROUND

1. Field

The present disclosure relates to a bipolar plate for a fuel cell, a method of manufacturing the bipolar plate, and a fuel cell including the bipolar plate.

2. Description of the Related Art

Fuel cells are power generating devices producing electric energy from chemical energy through oxidation and reduction reactions between hydrogen and oxygen.

Fuel cells use a stack of several to hundreds of unit cells since one unit cell has a low output voltage. In order to electrically connect the individual unit cells in a stack, bipolar plates are used. Bipolar plates separate different reaction gases and also act as flow paths of cooling water.

Such a bipolar plate is a core part of fuel cells together with a membrane-electrode assembly (MEA) and has multiple functions that include supporting structures of the MEA and gas diffusion layers, collecting and transferring current, transferring and removing reaction gases, and transferring cooling water to remove reaction heat. Therefore, there has been a demand for a bipolar plate having excellent electrical conductivity and resistance to corrosion.

However, currently known bipolar plates are not satisfactory in terms of electrical conductivity and resistance to corrosion, and thus, there is still a demand for further improvement.

### SUMMARY

Provided are bipolar plates for fuel cells that have improved resistance to corrosion, methods of manufacturing the bipolar plates, and fuel cells including the bipolar plates.

Additional aspects will be set forth in part in the description which follows and, in part, will be apparent from the description, or may be learned by practice of the presented embodiments.

According to an aspect of the present invention, a bipolar plate for a fuel cell includes:

a metal plate; and

a coating layer disposed on a surface of the metal plate, the coating layer including a polymer of an oxazine-based compound and a conducting material,

wherein the oxazine-based compound includes at least one compound selected from the compounds represented by Formulae 1 through 6 below:

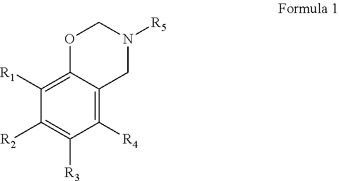

wherein, in Formula 1, R₁ through R₄ are each independently a hydrogen atom, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C2-C20 heteroaryl group, a substituted or unsubstituted C2-C20 heteroaryloxy group, a substituted or unsubstituted C4-C20 carbon ring group, a substituted or unsubstituted C4-C20 carbocyclic alkyl group, a substituted or unsubstituted C2-C20 heterocyclic group, a halogen atom, a hydroxyl group, or a cyano group; and

R₅ is a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 arylalkyl group, a substituted or unsubstituted C2-C20 heteroaryl group, a substituted or unsubstituted C2-C20 heteroaryloxy group, a substituted or unsubstituted C2-C20 heteroarylalkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group,

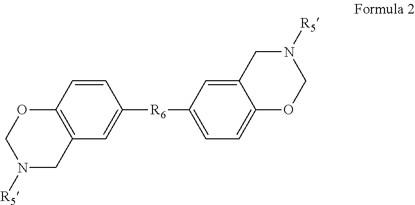

in Formula 2, R₅′ is a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 arylalkyl group, a substituted or unsubstituted C2-C20 heteroaryl group, a substituted or unsubstituted C2-C20 heteroaryloxy group, a substituted or unsubstituted C2-C20 heteroarylalkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group; and

R₆ is selected from the group consisting of a substituted or unsubstituted C1-C20 alkylene group, a substituted or unsubstituted C2-C20 alkenylene group, a substituted or unsubstituted C2-C20 alkynylene group, a substituted or unsubstituted C6-C20 arylene group, a substituted or unsubstituted C2-C20 heteroarylene group, —C(═O)—, and —SO₂—,

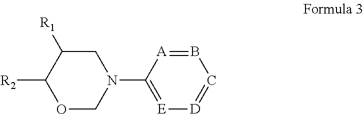

in Formula 3, A, B, C, D and E are all carbon; or one or two of A, B, C, D and E is nitrogen and the others are carbon; and

R₁ and R₂ are linked to form a ring, wherein the ring is a C6-C10 carbon ring group, a C3-C10 heteroaryl group, a fused C3-C10 heteroaryl group, a C3-C10 heterocyclic group or a fused C3-C10 heterocyclic group,

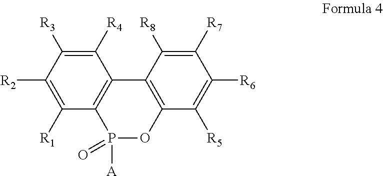

in Formula 4, A is a substituted or unsubstituted C1-C20 heterocyclic group, a substituted or unsubstituted C4-C20 cycloalkyl group, or a substituted or unsubstituted C1-C20 alkyl group; and

R₁ through R₈ are each independently a hydrogen atom, a C1-C20 alkyl group, a C1-C20 alkoxy group, a C6-C20 aryl group, a C6-C20 aryloxy group, a C1-C20 heteroaryl group, a C1-C20 heteroaryloxy group, a C4-C20 cycloalkyl group, a C1-C20 heterocyclic group, a halogen atom, a cyano group, or a hydroxyl group, wherein at least one of A and R₁ through R₈ comprises a benzoxazine group,

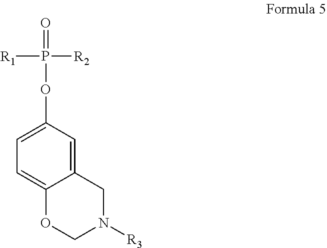

in Formula 5, R₁ and R₂ are each independently a C1-C20 alkyl group, a C1-C20 alkoxy group, a C6-C20 aryl group, a C6-C20 aryloxy group or a group represented by Formula 5A below,

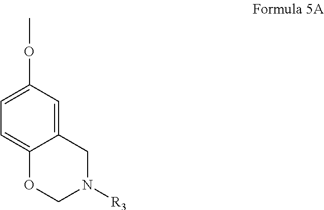

in Formulae 5 and 5A, R₃ is a hydrogen atom, a C1-C20 alkyl group, a C1-C20 alkoxy group, a C6-C20 aryl group, a C6-C20 aryloxy group, a halogenated C6-C20 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heterocyclic group or a halogenated C1-C20 heterocyclic group.

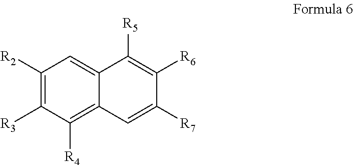

in Formula 6, at least two adjacent groups selected from among R₂, R₃ and R₄ are linked to form a group represented by Formula 2A below, and the non-selected, remaining group is a hydrogen atom, a C1-C20 alkyl group, a C1-C20 alkoxy group, a C6-C20 aryl group, a C6-C20 aryloxy group, a halogenated C6-C20 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heterocyclic group or a halogenated C1-C20 heterocyclic group; and

at least two adjacent groups selected from among R₅, R₆ and R₇ are linked to form the group represented by Formula 2A below, and the non-selected, remaining group is a C1-C20 alkyl group, a C1-C20 alkoxy group, a C6-C20 aryl group, a C6-C20 aryloxy group, a halogenated C6-C20 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heterocyclic group or a halogenated C1-C20 heterocyclic group,

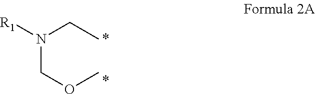

in Formula 2A, R₁ is a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 arylalkyl group, a substituted or unsubstituted C2-C20 heteroaryl group, a substituted or unsubstituted C2-C20 heteroaryloxy group, a substituted or unsubstituted C2-C20 heteroarylalkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group; and

* denotes the sites at which the at least two adjacent groups selected from among R2, R3 and R4 of Formula 6 and the at least two adjacent groups selected from among R5, R6 and R7 are linked, respectively.

According to another aspect of the present invention, a method of manufacturing a bipolar plate for a fuel cell, the method includes:

coating a surface of a metal plate with a coating layer forming composition including at least one oxazine-based compound selected from compounds represented by Formulae 1 through 6 below, a conducting material, and a solvent; and

thermally treating the metal plate coated with the coating layer forming composition.

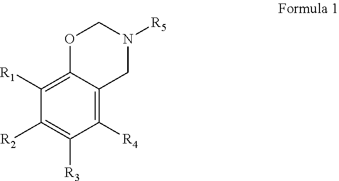

wherein in Formula 1, R₁ through R₄ are each independently a hydrogen atom, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C2-C20 heteroaryl group, a substituted or unsubstituted C2-C20 heteroaryloxy group, a substituted or unsubstituted C4-C20 carbon ring group, a substituted or unsubstituted C4-C20 carbocyclic alkyl group, a substituted or unsubstituted C2-C20 heterocyclic group, a halogen atom, a hydroxyl group, or a cyano group; and

R₅ is a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 arylalkyl group, a substituted or unsubstituted C2-C20 heteroaryl group, a substituted or unsubstituted C2-C20 heteroaryloxy group, a substituted or unsubstituted C2-C20 heteroarylalkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group,

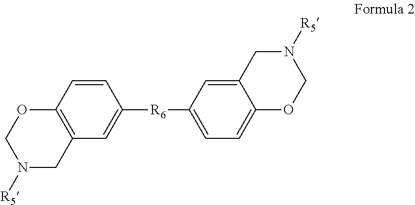

in Formula 2, R₅′ is a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 arylalkyl group, a substituted or unsubstituted C2-C20 heteroaryl group, a substituted or unsubstituted C2-C20 heteroaryloxy group, a substituted or unsubstituted C2-C20 heteroarylalkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group; and

R₆ is selected from the group consisting of a substituted or unsubstituted C1-C20 alkylene group, a substituted or unsubstituted C2-C20 alkenylene group, a substituted or unsubstituted C2-C20 alkynylene group, a substituted or unsubstituted C6-C20 arylene group, a substituted or unsubstituted C2-C20 heteroarylene group, —C(═O)—, and —SO₂—,

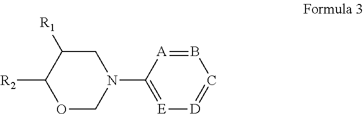

in Formula 3, A, B, C, D and E are all carbon; or one or two of A, B, C, D and E is nitrogen and the others are carbon; and

R₁ and R₂ are linked to form a ring, wherein the ring is a C6-C10 cycloalkyl group, a C3-C10 heteroaryl group, a fused C3-C10 heteroaryl group, a C3-C10 heterocyclic group or a fused C3-C10 heterocyclic group,

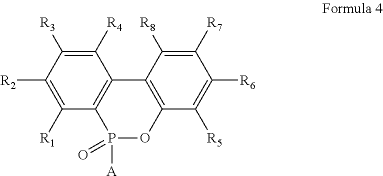

in Formula 4, A is a substituted or unsubstituted C1-C20 heterocyclic group, a substituted or unsubstituted C4-C20 cycloalkyl group, or a substituted or unsubstituted C1-C20 alkyl group;

R₁ through R₈ are each independently a hydrogen atom, a C1-C20 alkyl group, a C1-C20 alkoxy group, a C6-C20 aryl group, a C6-C20 aryloxy group, a C1-C20 heteroaryl group, a C1-C20 heteroaryloxy group, a C4-C20 cycloalkyl group, a C1-C20 heterocyclic group, a halogen atom, a cyano group, or a hydroxyl group, wherein at least one of A and R₁ through R₈ comprises a benzoxazine group,

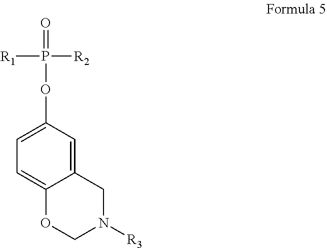

in Formula 5, R₁ and R₂ are each independently a C1-C20 alkyl group, a C1-C20 alkoxy group, a C6-C20 aryl group, a C6-C20 aryloxy group or a group represented by Formula 5A below,

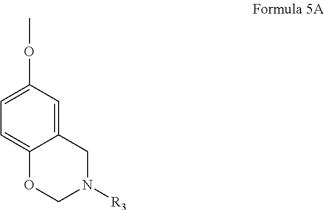

in Formulae 5 and 5A, R₃ is a hydrogen atom, a C1-C20 alkyl group, a C1-C20 alkoxy group, a C6-C20 aryl group, a C6-C20 aryloxy group, a halogenated C6-C20 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heterocyclic group or a halogenated C1-C20 heterocyclic group,

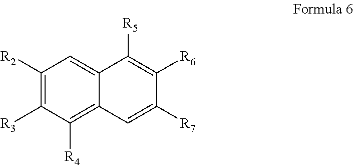

in Formula 6, at least two adjacent groups selected from among R₂, R₃ and R₄ are linked to form a group represented by Formula 2A below, and the non-selected, remaining group is a hydrogen atom, a C1-C20 alkyl group, a C1-C20 alkoxy group, a C6-C20 aryl group, a C6-C20 aryloxy group, a halogenated C6-C20 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heterocyclic group or a halogenated C1-C20 heterocyclic group; and

at least two adjacent groups selected from among R₅, R₆ and R₇ are linked to form the group represented by Formula 2A below, and the non-selected, remaining group is a C1-C20 alkyl group, a C1-C20 alkoxy group, a C6-C20 aryl group, a C6-C20 aryloxy group, a halogenated C6-C20 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heterocyclic group or a halogenated C1-C20 heterocyclic group,

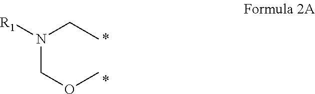

in Formula 2A, R₁ is a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 arylalkyl group, a substituted or unsubstituted C2-C20 heteroaryl group, a substituted or unsubstituted C2-C20 heteroaryloxy group, a substituted or unsubstituted C2-C20 heteroarylalkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group; and

*denotes the sites at which the at least two adjacent groups selected from

among R₂, R₃ and R₄ of Formula 6 and the at least two adjacent groups selected from among R₅, R₆ and R₇ are linked, respectively.

According to another aspect of the present invention, a fuel cell includes the bipolar plate.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a bipolar plate for a fuel cell, according to an embodiment of the present disclosure;

FIG. 2 is a graph illustrating resistance characteristics of bipolar plates for a fuel cell manufactured according to Examples 1-1 to 1-3 with respect to applied pressure;

FIG. 3 is a graph illustrating resistance characteristics of bipolar plates for a fuel cell manufactured according to Examples 2-1 to 2-3 with respect to applied pressure;

FIG. 4 is a graph illustrating resistance characteristics of bipolar plates for a fuel cell manufactured according to Examples 3-1 to 3-5 with respect to applied pressure;

FIG. 5 is a graph illustrating resistance characteristics of bipolar plates for a fuel cell manufactured according to Comparative Examples 1 through 3 with respect to applied pressure;

FIG. 6 is a graph illustrating the results of a test of resistance to acid performed on bipolar plates for a fuel cell manufactured according to Examples 2-1 and 2-2 and Comparative Examples 1 and 2;

FIG. 7 is a graph illustrating resistance characteristics of bipolar plates for a fuel cell according to Examples 4-1 through 4-4 with respect to applied pressure;

FIG. 8 is an exploded perspective view of a fuel cell according to an embodiment of the present disclosure; and

FIG. 9 is a cross-sectional diagram of a membrane-electrode assembly included in the fuel cell of FIG. 8.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

According to an aspect of the present invention, a bipolar plate for a fuel cell includes a metal plate and a coating layer disposed on a surface of the metal plate, the coating layer including a polymer of an oxazine-based compound, particularly a benzoxazine compound, and a conducting material.

The polymer of the oxazine-based compound, which is coated on the surface of the metal layer together with the conducting material, is resistant to acid. Thus, the bipolar plate has excellent electrical conductivity, has good excellent resistance to acid, and improved resistance to corrosion.

The oxazine-based compound includes at least one compound selected from the compounds represented by Formulae 1 through 6 below:

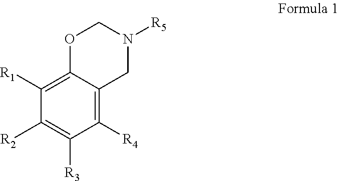

In Formula 1, R₁ through R₄ are each independently a hydrogen atom, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₂-C₂₀ heteroaryl group, a substituted or unsubstituted C₂-C₂₀ heteroaryloxy group, a substituted or unsubstituted C₄-C₂₀ carbon ring group, a substituted or unsubstituted C₄-C₂₀ carbocyclic alkyl group, a substituted or unsubstituted C₂-C₂₀ heterocyclic group, a halogen atom, a hydroxyl group, or a cyano group; and

R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group,

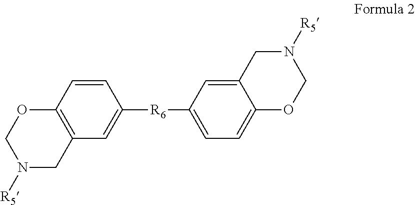

In Formula 2, R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and

R₆ is selected from the group consisting of a substituted or unsubstituted alkylene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₂-C₂₀ heteroarylene group, —C(═O)—, and —SO₂—.

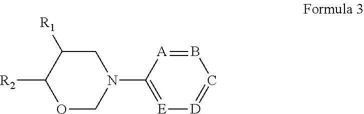

In Formula 3, A, B, C, D and E are all carbon; or one or two of A, B, C, D and E is nitrogen and the others are carbon, and

R₁ and R₂ are linked to form a ring,
wherein the ring is a C₆-C₁₀ carbon ring group, a C₃-C₁₀ heteroaryl group, a fused C₃-C₁₀ heteroaryl group, a C₃-C₁₀ heterocyclic group or a fused C₃-C₁₀ heterocyclic group.

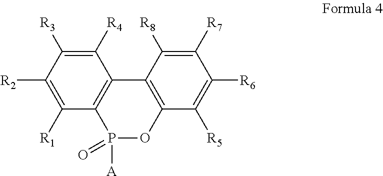

In Formula 4, A is a substituted or unsubstituted C₁-C₂₀ heterocyclic group, a substituted or unsubstituted C₄-C₂₀ cycloalkyl group, or a substituted or unsubstituted C₁-C₂₀ alkyl group; and

R₁ through R₈ are each independently a hydrogen atom, a C₁-C₂₀ alkyl group, a C₁-C₂₀ alkoxy group, a C₆-C₂₀ aryl group, a C₆-C₂₀ aryloxy group, a C₁-C₂₀ heteroaryl group, a C₁-C₂₀ heteroaryloxy group, a C₄-C₂₀ cycloalkyl group, a C₁-C₂₀ heterocyclic group, a halogen atom, a cyano group, or a hydroxyl group, wherein at least one of A and R₁ through R₈ comprises a benzoxazine group.

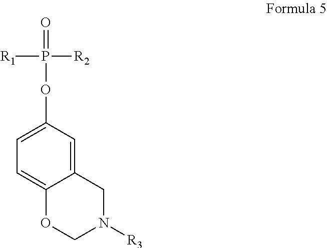

In Formula 5, R₁ and R₂ are each independently a C₁-C₂₀ alkyl group, a C₁-C₂₀ alkoxy group, a C₆-C₂₀ aryl group, a C₆-C₂₀ aryloxy group or a group represented by Formula 5A below.

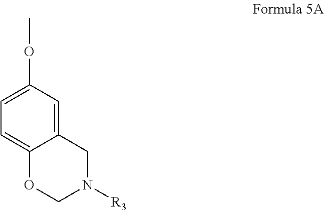

In Formulae 5 and 5A, R₃ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group.

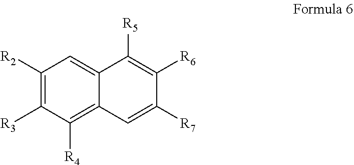

In Formula 6, at least two adjacent groups selected from among R₂, R₃ and R₄ are linked to form a group represented by Formula 2A below, and the non-selected, remaining group is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group; and

at least two adjacent groups selected from among R₅, R₆ and R₇ are linked to form the group represented by Formula 2A below, and the non-selected, remaining group is a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group.

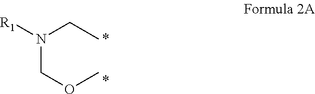

In Formula 2A, R₁ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and

* denotes the sites at which the at least two adjacent groups selected from among R₂, R₃ and R₄ of Formula 6 and the at least two adjacent groups selected from among R₅, R₆ and R₇ of Formula 6 are linked, respectively.

In Formula 2A, R₁ is selected from the groups represented by the following formulae.

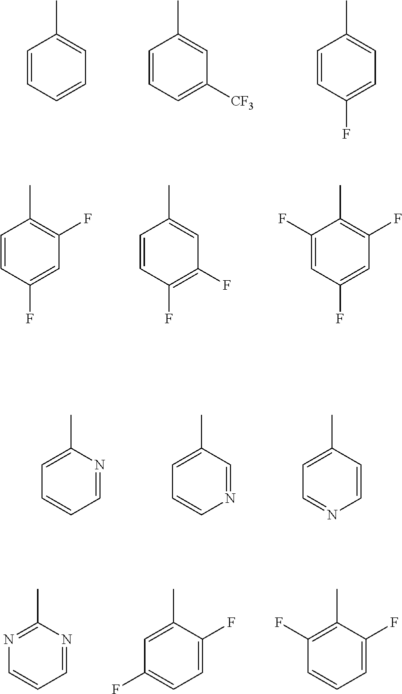

It is to be understood that in all of the formulae provided herein, substituents such as R₁, R₂, etc. are not universally defined. Instead, particular definitions for these substituents are provided for each specific formula or groups of related formulae, as indicated.

Examples of the benzoxazine-based monomer of Formula 1 may include compounds represented by the following formulae.

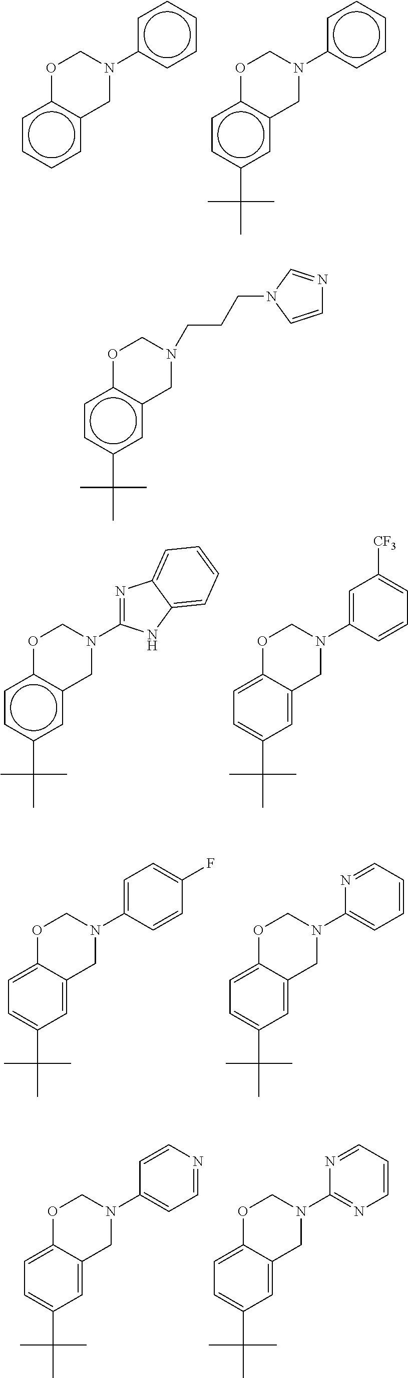

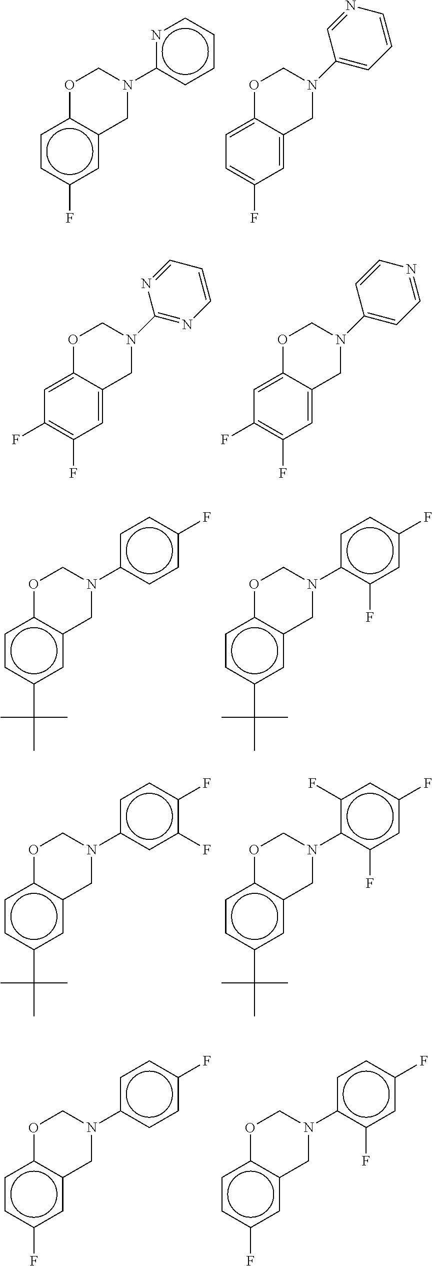

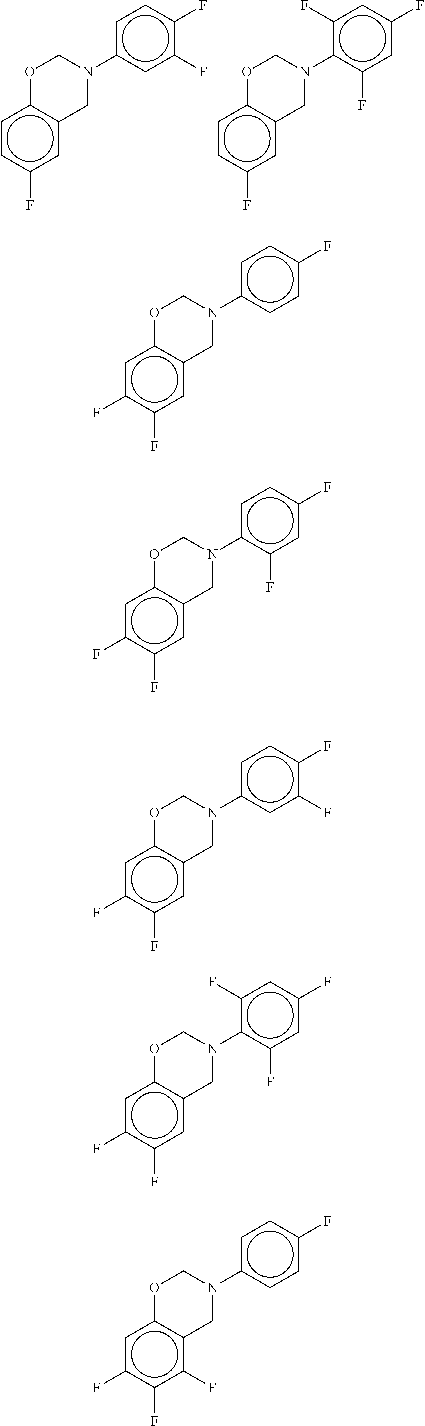

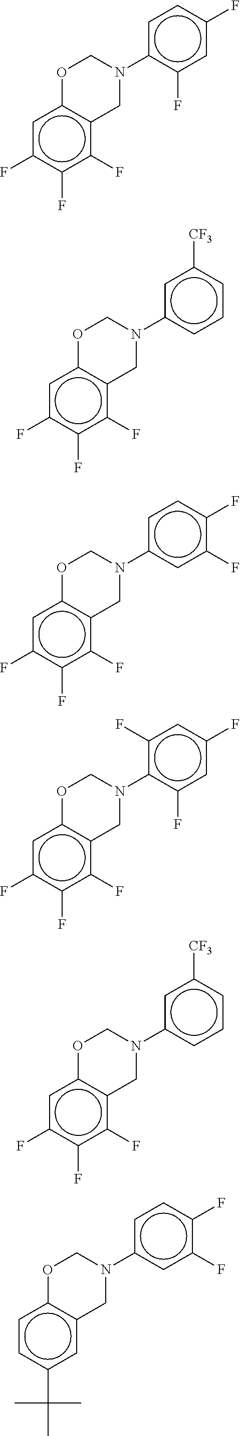

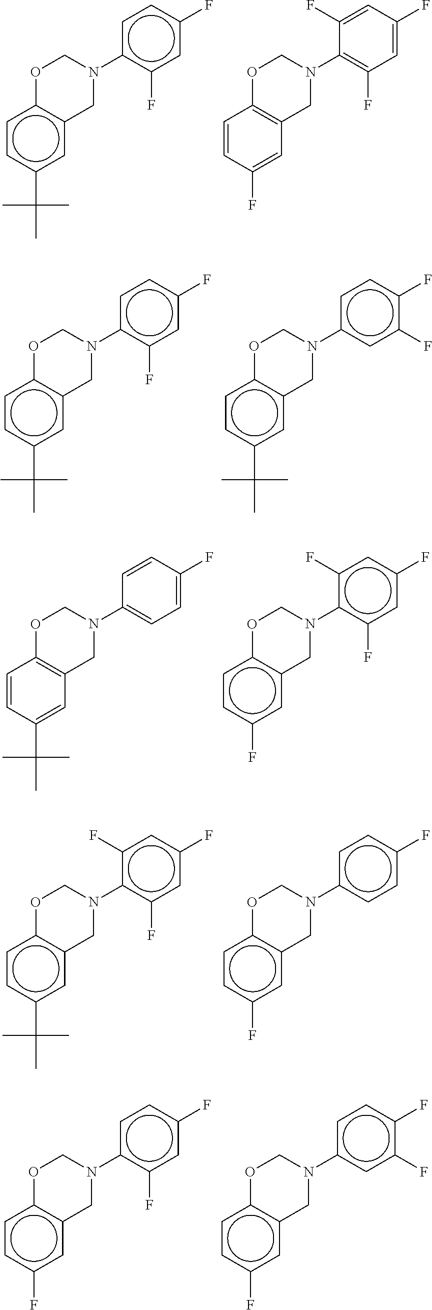

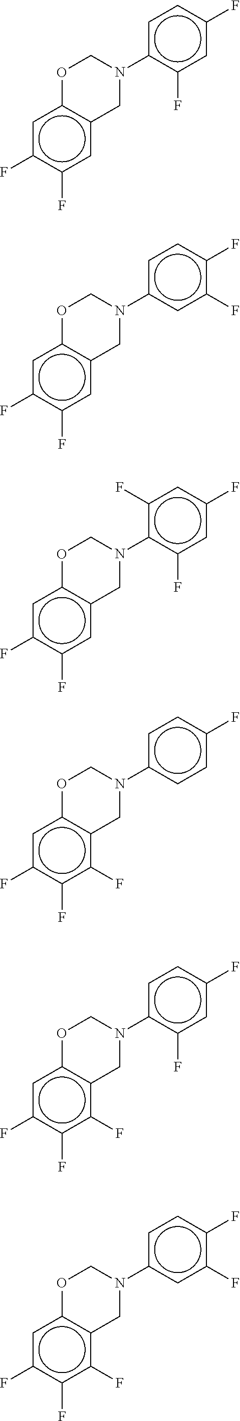

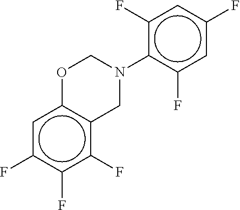

Examples of the benzoxazine-based monomer of Formula 2 may include compounds represented by the following formulae.

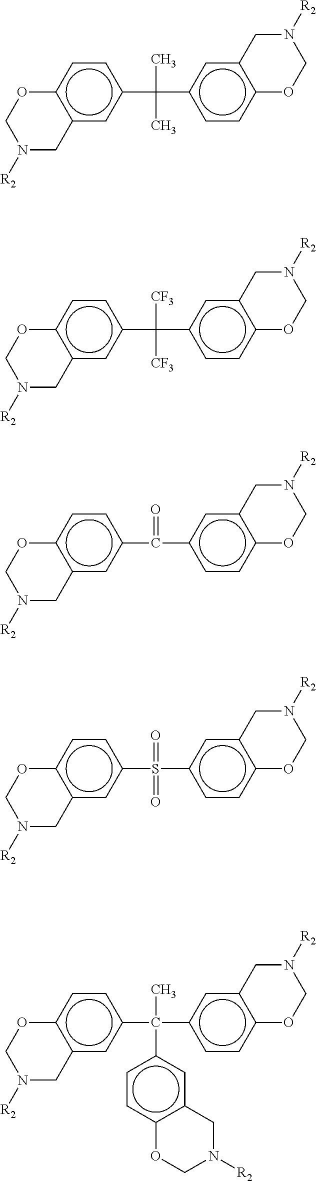

In the formulae above, R₂ is a phenyl group, —CH₂—CH═CH₂, or one of the groups represented by the following formulae:

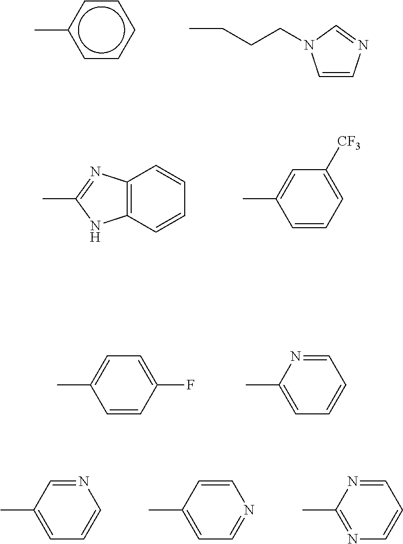

For example, the compound of Formula 2 may be selected from the compounds represented by the following formulae:

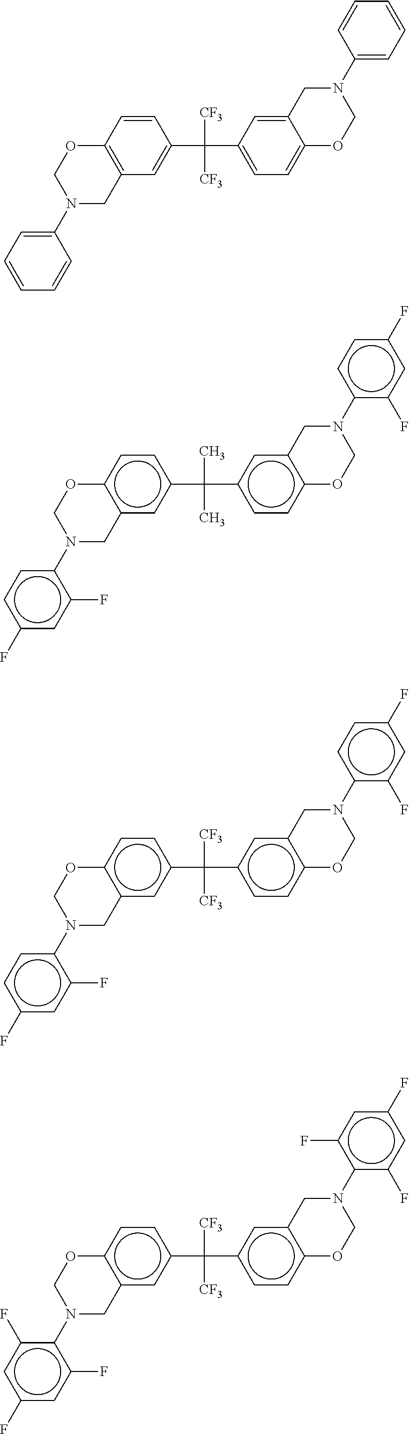

Examples of the oxazine-based monomer of Formula 3 may include compounds represented by the following formulae.

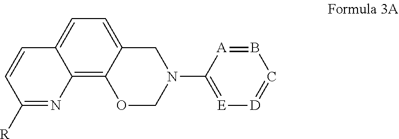

In Formula 3A, R is a hydrogen atom or a C₁-C₁₀ alkyl group.

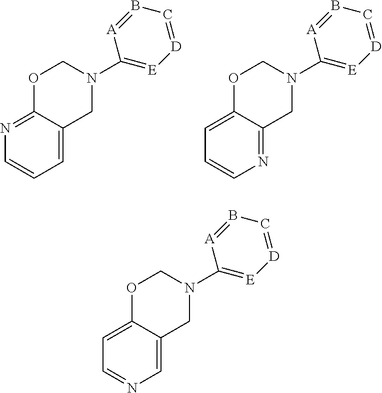

In Formula 3 above,

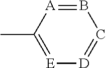

is selected from the groups represented by the following formulae.

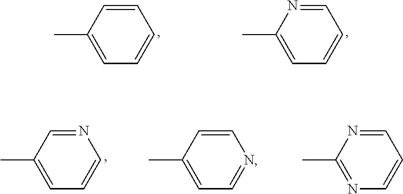

Specific examples of the oxazine-based monomer of Formula 3 may include compounds represented by the following formulae.

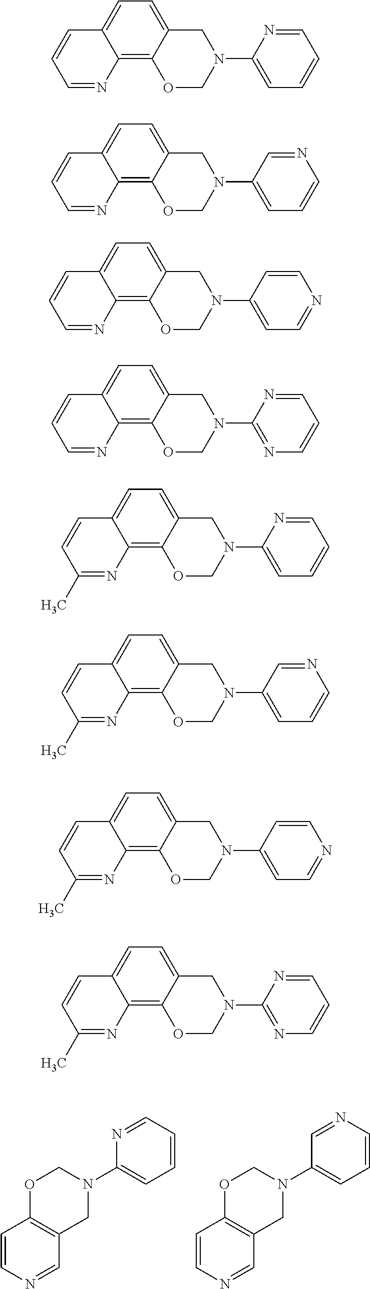

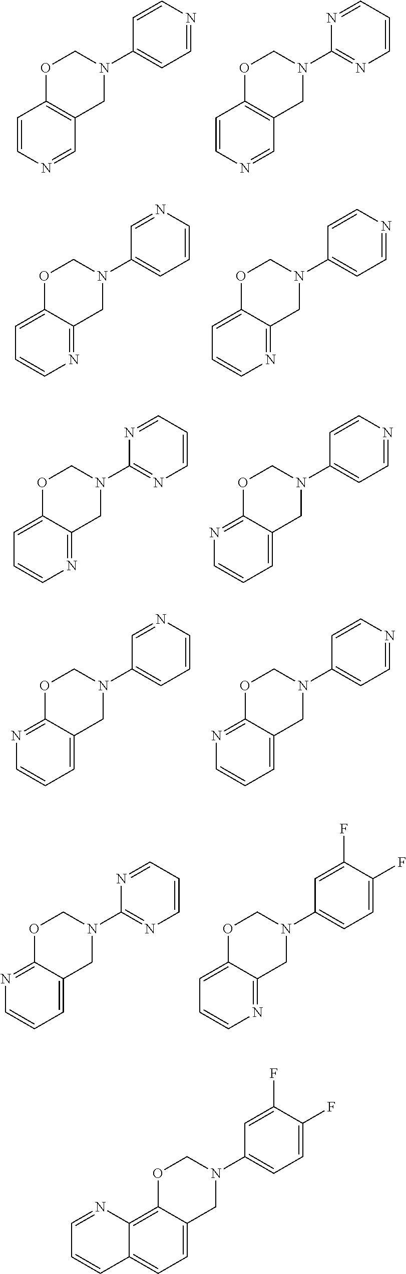

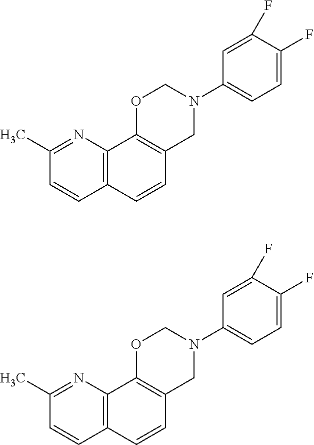

Examples of the benzoxazine-based monomer of Formula 4 include compounds represented by the following formulae.

In Formula 4, A may be selected from the groups represented by Formulae 4A and 4B below.

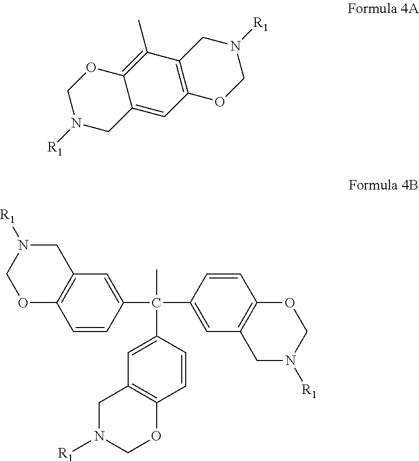

In Formulae 4A and 4B, R₁ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group.

Examples of the benzoxazine-based monomer of Formula 4 containing phosphorous include compounds represented by Formulae 4C and 4D below.

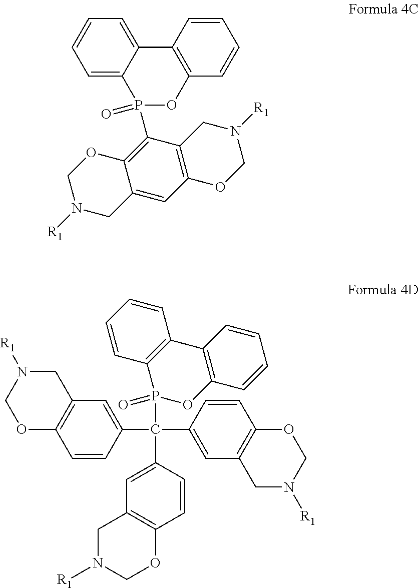

In Formulae 4C and 4D, R₁ may be selected from the groups represented by the following formulae.

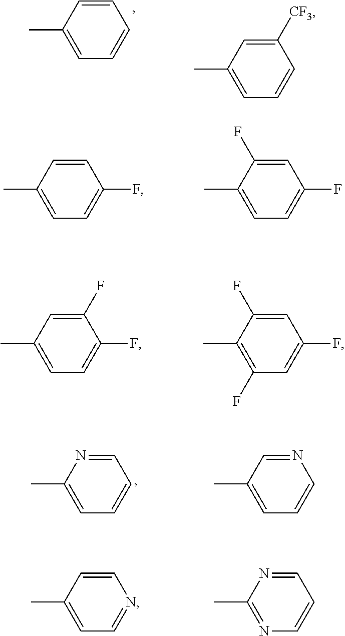

Specific examples of the benzoxazine-based monomer of Formula 4 include the compounds represented by the following formulae:

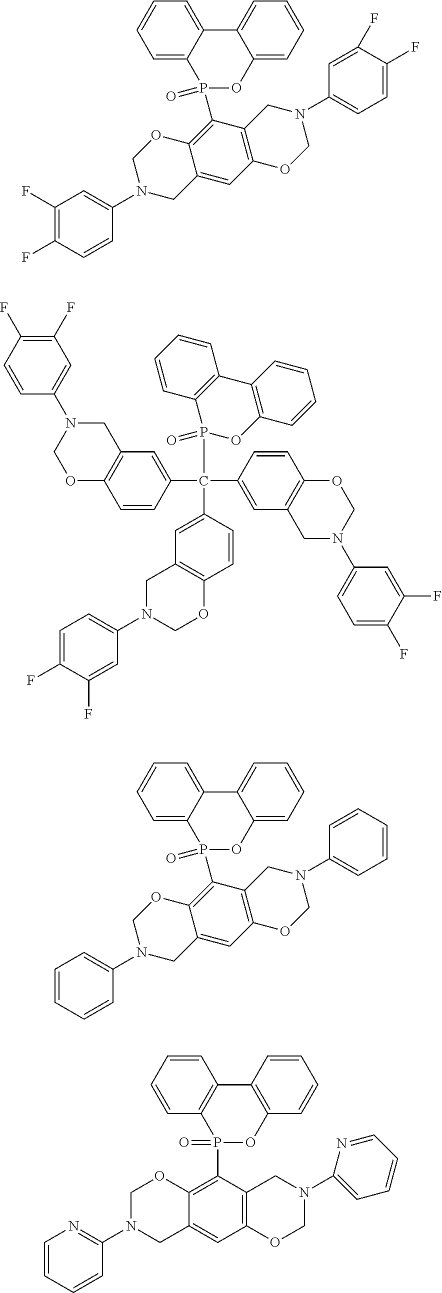

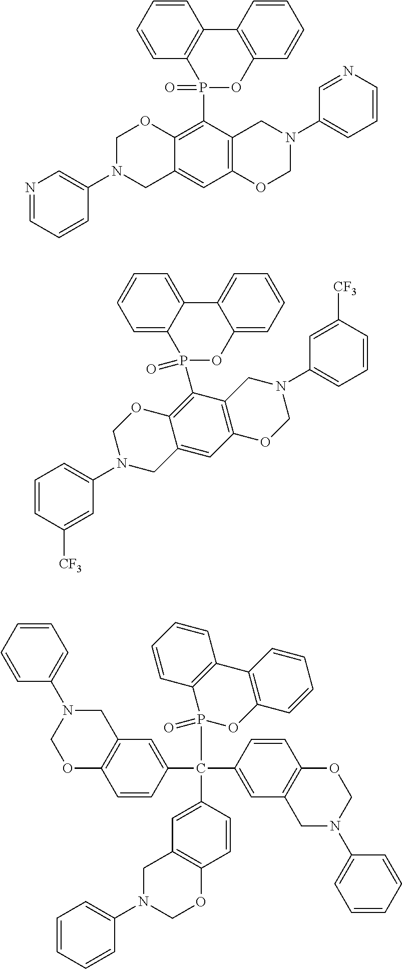

Examples of the benzoxazine-based monomer of Formula 5 include compounds represented by Formulae 5B, 5C and 5D below.

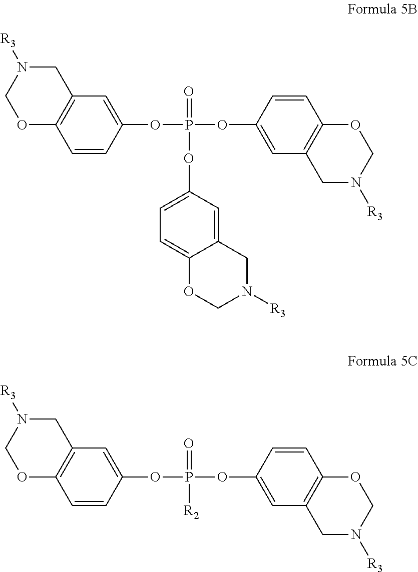

In Formulae 5B and 5C, R₂ is a C₁-C₁₀ alkyl group, a C₁-C₁₀ alkoxy group, a C₆-C₁₀ aryl group, or a C₆-C₁₀ aryloxy group; and R₃ is selected from the groups represented by the following formulae:

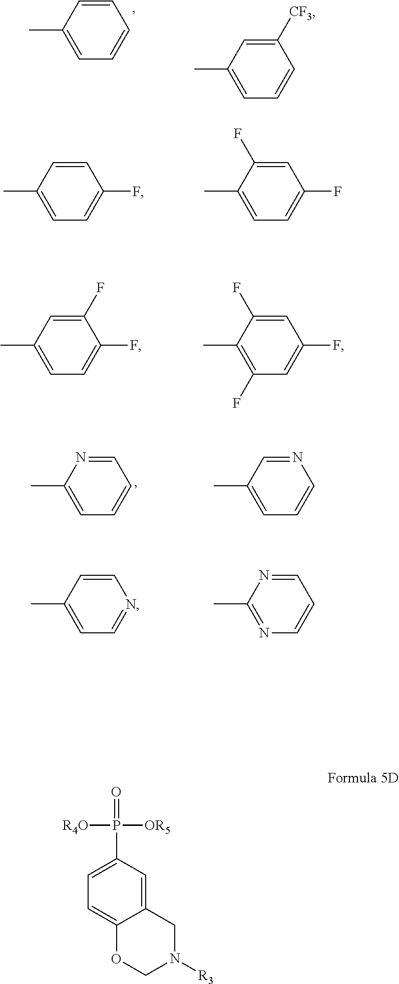

In Formula 5D, R₄ and R₅ are each independently a C₆-C₁₀ aryl group; and R₃ is selected from the groups represented by the following formulae:

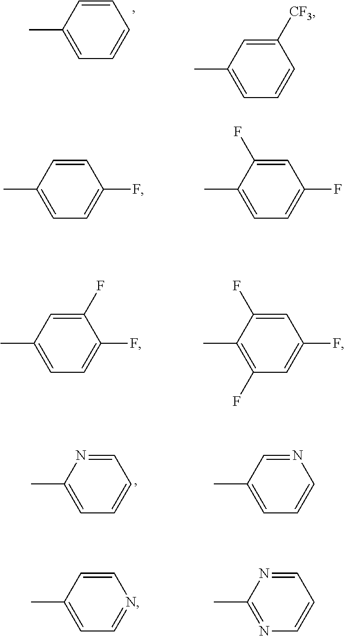

Examples of the compound of Formula 5 include compounds represented by Formulae 5E and 5F below:

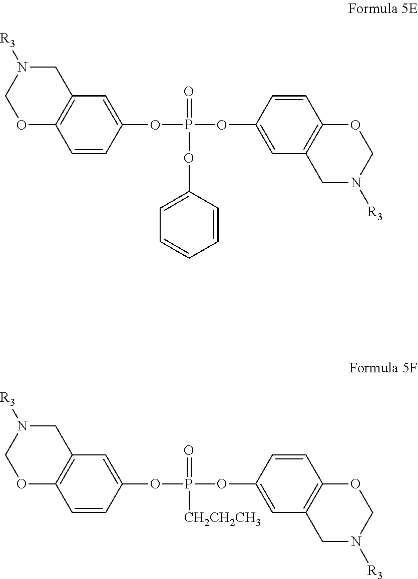

In Formulae 5E and 5F, R₃ is selected from the groups represented by the following formulae.

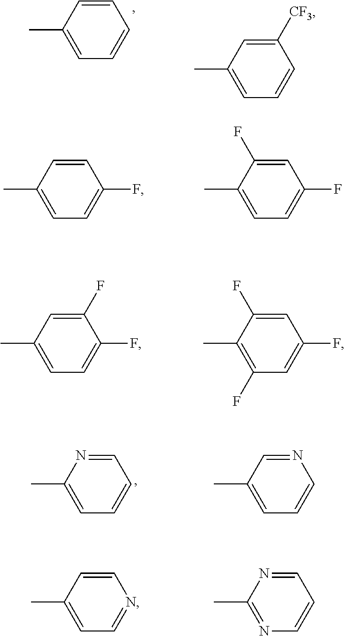

Specific examples of the benzoxazine-based monomer of Formula 5 include compounds represented by the following formulae.

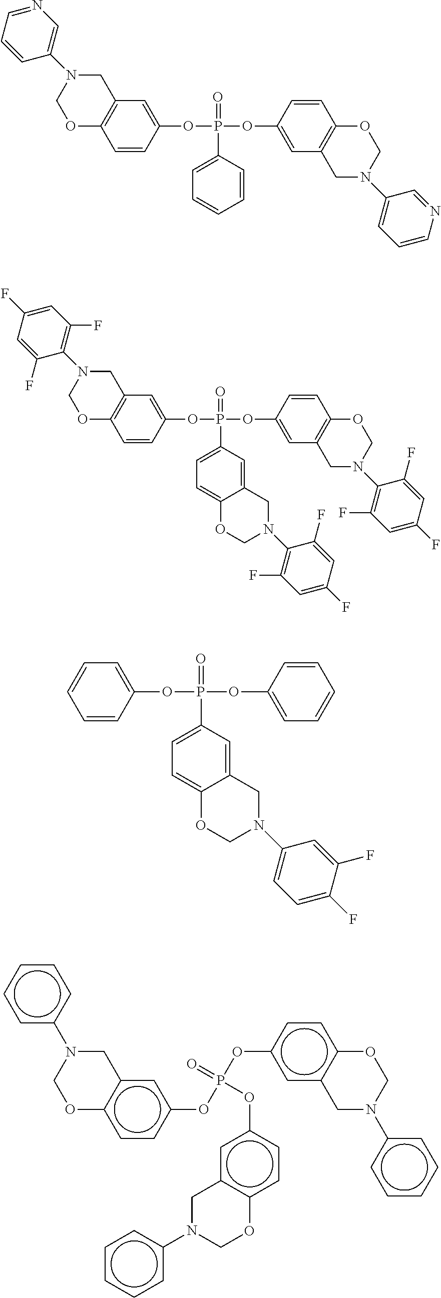

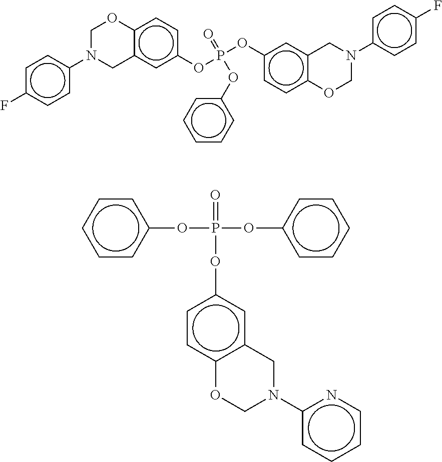

Examples of the benzoxazine-based monomer of Formula 6 include compounds represented by Formulae 6A through 6C.

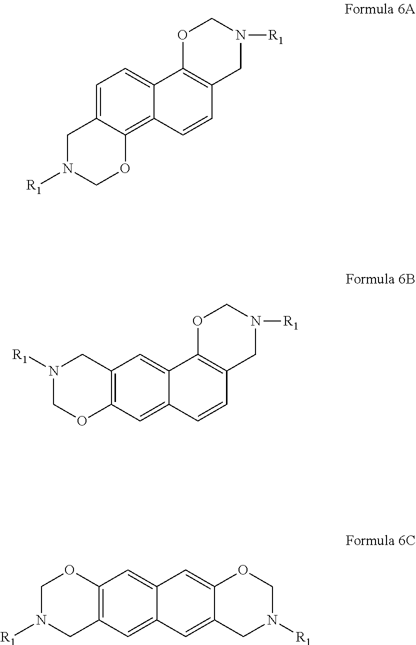

In Formulae 6A through 6C, R₁ is selected from the groups represented by the following formulae.

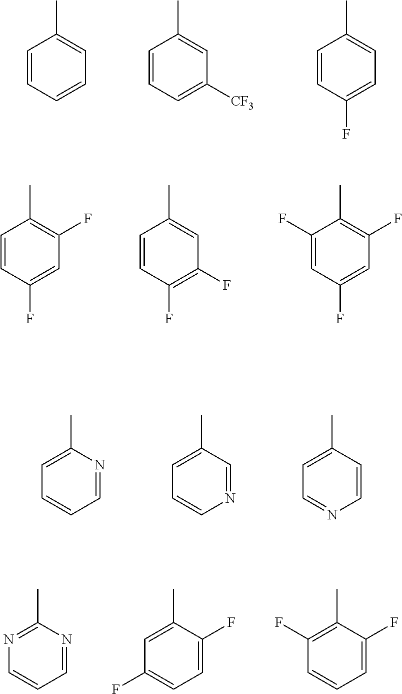

Specific examples of the benzoxazine-based monomer of Formula 6 include compounds represented by the following formulae.

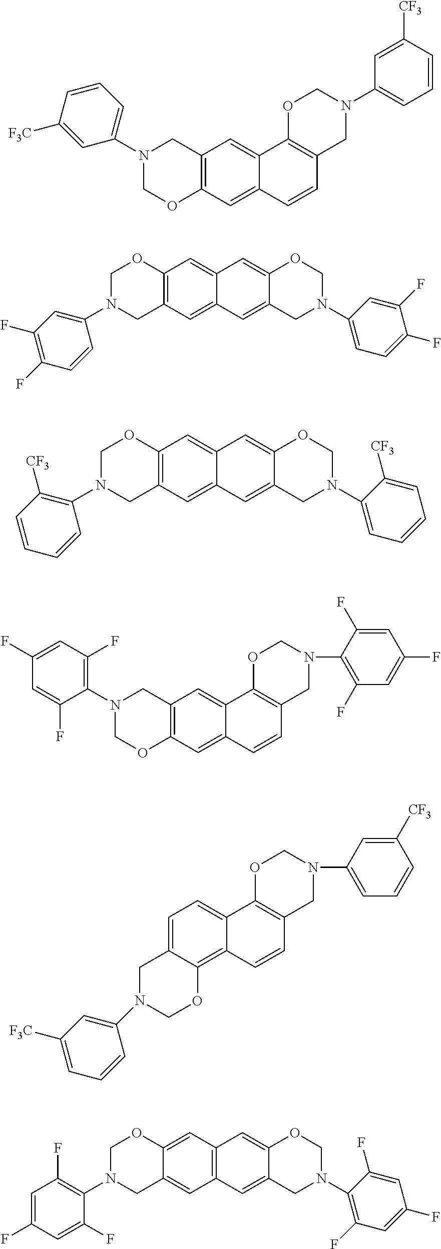

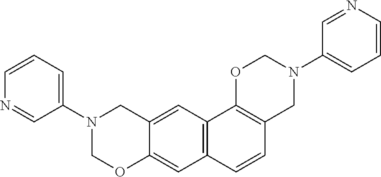

The oxazine-based compound may be at least one compound selected from the group consisting of a compound (t-BuPh) of Formula 7, a compound (t-PPO-a) of Formula 8, a compound (4-DFPh-4AP) of Formula 9, a compound (HF-a) of Formula 10, a compound (27-DHN-34DFA) of Formula 11, a compound (3,4-DFPh-4FA) of Formula 12, a compound (3HP-2AP) of Formula 13, and a compound (BPS-A) of Formula 14.

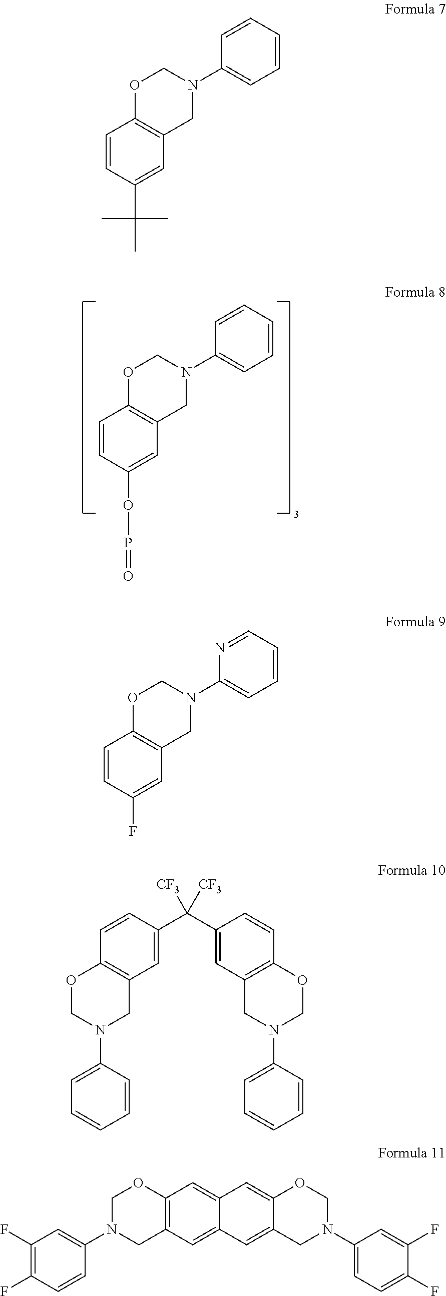

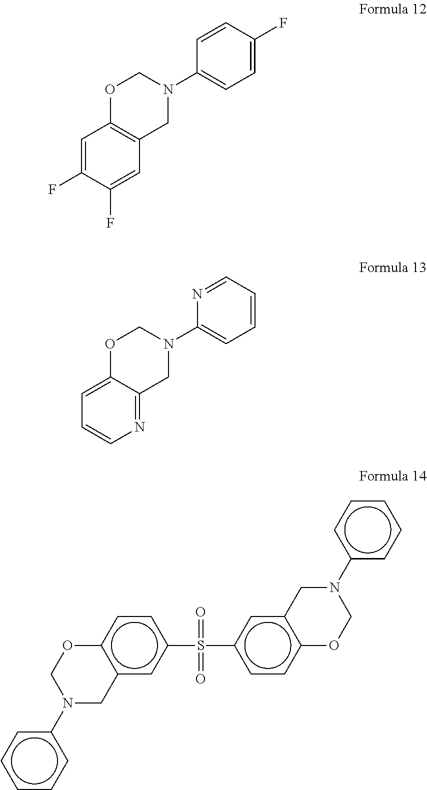

The conducting material in the coating layer may include a carbonaceous material having a specific surface area of about 60 to about 250 m²/g, and an average particle diameter of about 0.1 to about 10 um.

The conducting material may be, for example, at least one material selected from the group consisting of carbon black, graphite and carbon nanotubes.

Examples of the conducting material include MCMB (Osaka gas), Vulcan XC-72 (Cabot Corporation) and Timrex (Timcal Graphite & Carbon), which are commercially available.

In this regard, “MCMB” is the product name of a microcarbon microbead, “Vulcan XC-72” is the product name a carbon black, “Timrex” is a product name of a graphite. In particular, the term “Timrex” as used in the examples herein refers to Timrex HSAG 300 graphite.

The amount of the conducting agent in the coating layer may be in the range of about 0.25 to about 10 parts by weight, for example, about 0.5 to about 2 parts by weight, based on 1 part by weight of the polymer of the benzoxazine-based compound. When the amount of the conducting material is within this range, resistance to corrosion and electrical conductivity of the bipolar plate may be excellent.

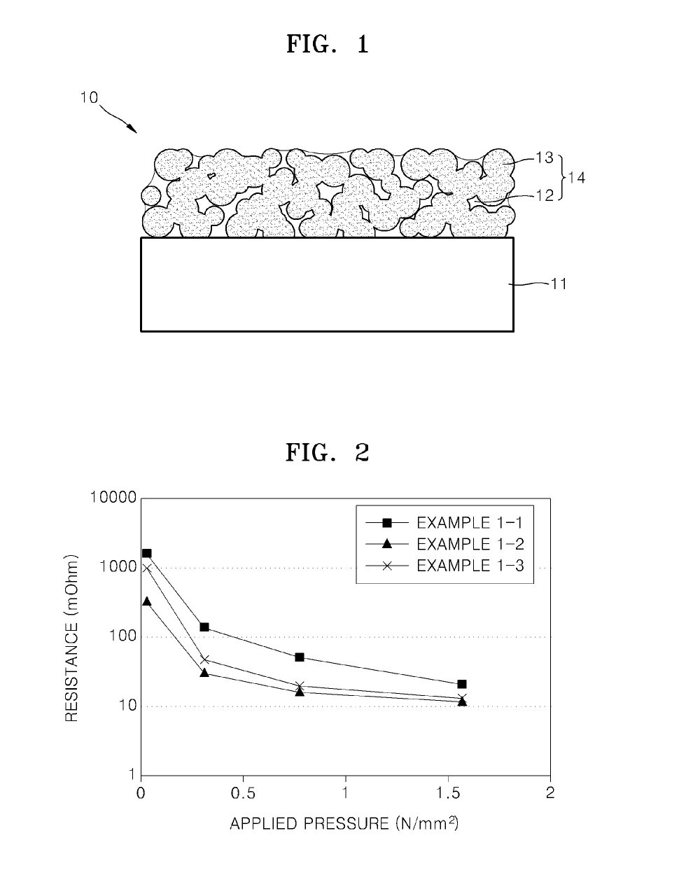

FIG. 1 is a sectional view of a bipolar plate 10 for a fuel cell, according to an embodiment of the present disclosure.

Referring to FIG. 1, the bipolar plate 10 includes a metal plate 11 and a coating layer 14 disposed on a surface of the metal plate 11.

The coating layer 14 may have a thickness of about 1 to about 100 μm.

The coating layer 14 may include a polymer 12 of a benzoxazine-based compound and a conducting material 13. Herein, the polymer 12 of the benzoxazine-based compound may act as a binder of the conducting material 13 and the metal plate 11 and may also prevent a contact between the metal plate 11 and acid.

The conducting material 13 facilitates electrical conduction and minimizes contact resistance between the metal plate 11 and a gas diffusion layer disposed on the metal plate 11. The metal plate 11 is an electrically conductive support including a path for supplying gas.

The metal plate 11 may be formed using any substrate made of a conductive metal or an alloy thereof. For example, the metal plate 11 may be formed using a stainless steel plate, an aluminum plate, a carbon steel plate, or the like.

The metal plate 11 may have a thickness of about 1 mm to about 5 mm.

Although not illustrated in FIG. 1, the metal plate 11 may have one or more grooves.

Hereinafter, a method of manufacturing the bipolar plate for a fuel cell, according to an embodiment of the present disclosure, will be described.

Initially, a metal plate is optionally subjected to a surface process.

Impurities and an oxide film are removed from a surface of the metal plate through the surface process. Furthermore, grooves may be formed in the surface of the metal plate as a result of the surface process, thereby enlarging the surface area of the metal plate, enhancing the binding force to the coating layer on the metal plate, and reducing contact resistance.

The surface process may include at least one process selected from the group consisting of etching, brushing, sandpapering and blasting.

Etching may be performed using an etching solution, for example, about 5 to 50% sulfuric acid solution.

The metal plate, after the etching, is washed with water and then dried until the liquid is completely removed from the surface of the metal plate. An oxide film may be removed from the surface of the metal plate through the etching process.

Brushing is a process of forming grooves in the surface of the metal plate by brushing the surface with a steel brush or like.

Sandpapering is a process of forming grooves in the surface of the metal plate by rubbing with sandpaper at an appropriate force.

Blasting is a process of treating the surface of the metal plate by jetting a fine powder, such as alumina (Al₂O₃), glass beads, or ceramic beads, against the surface of the metal plate at a high pressure.

As a result of the surface process, a groove having a depth and a width, each ranging from about 5 to about 20 μm, may be formed in the metal plate. For example, a groove having a depth and a width with about 5, 10, or 20 μm may be formed.

The groove may be formed as, for example, a matrix.

The metal plate including the groove formed through the surface process has a larger surface area than a metal plate without any groove. The formed grooves may enhance the binding force of the metal plate to the coating layer.

The surface of the metal plate treated as described above is coated with a coating layer forming composition including an oxazine-based compound, a conducting material and a solvent to form a coating layer.

The amount of the conducting material may be in the range of about 0.25 to about 10 parts by weight, for example, about 1 to about 4 parts by weight, based on 1 part by weight of the oxazine-based compound.

When the amount of the conducting material is within this range, electrical conductivity and resistance to corrosion of the bipolar plate may be excellent.

The solvent may be an organic solvent, such as N,N-dimethylacetamide (DMAC), N,N-dimethylformamide (DMF), or the like, which may be used alone or in combination.

The amount of the solvent may be in the range of about 300 to about 1000 parts by weight based on 100 parts by weight of the oxazine-based compound. When the amount of the solvent is within this range, it may be easier to coat the coating layer forming composition.

The coating of the coating layer forming composition may be performed using spray coating, dip coating, roll coating, Pape casting or the like.

After the coating process, a drying process may be performed, for example, at a temperature of about 40 to about 80° C.

After the coating and drying processes, the metal plate with the dried coating layer is thermally treated, thereby completing the manufacture of the bipolar plate for a fuel cell that includes the polymer of the oxazine-based compound and the conducting material.

The oxazine-based compound is polymerized through the thermal treatment, thereby resulting in the polymer of the oxazine-based compound in the coating layer.

The thermal treatment may be performed at a temperature of about 150 to 280° C., for example, at a temperature of about 190 to about 260° C. When the temperature of the thermal treatment is within this range, polymerization reactivity of the oxazine-based compound may be excellent.

The duration of the thermal treatment may vary according to the temperature of the thermal treatment. For example, the duration of the thermal treatment may be in the range of about 1 to about 5 hours.

The bipolar plate for a fuel cell manufactured as described above has excellent corrosion current and contact resistance characteristics in a wide range of temperatures and may be manufactured on a large scale at lower costs.

A fuel cell including the bipolar plate for a fuel cell may be manufactured using general methods.

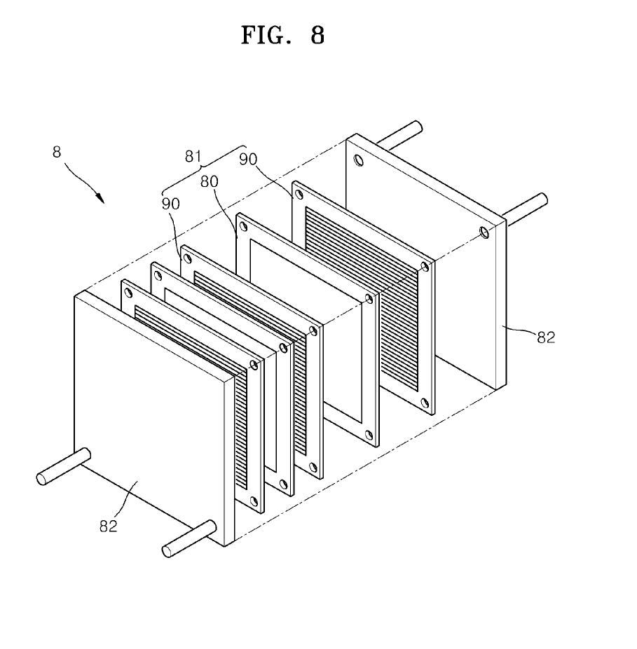

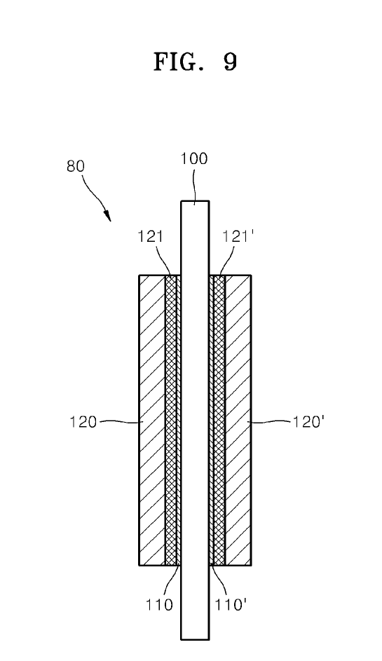

FIG. 8 is a perspective exploded view of a fuel cell 8 according to an embodiment of the present disclosure. FIG. 9 is a cross-sectional diagram of a membrane-electrode assembly (MEA) of the fuel cell of FIG. 8.

Referring to FIG. 8, the fuel cell 8 includes two unit cells 81 that are supported by a pair of holders 82. Each of the unit cells 81 includes an MEA 80, and bipolar plates 90 respectively disposed on opposite sides of the MEA 10 in the thickness direction thereof, wherein each of the bipolar plates 90 includes a metal plate and a coating layer that is disposed on a surface of the metal plate and includes a polymer of a oxazine-based compound and a conducting agent, as in an embodiment of the present disclosure described above. The bipolar plates 90, which are bound to the MEA 80, function as current collectors, and at the same time provide oxygen and fuel to catalyst layers of the MEAs 80.

Although only two unit cells 81 are illustrated in FIG. 8, the number of unit cells is not limited to two and a fuel cell may have several tens or hundreds of unit cells, depending on the desired properties of the fuel cell.

As shown in FIG. 9, the MEA 80 includes an electrolyte membrane 100, catalyst layers 110 and 110′ disposed on lateral sides of the electrolyte membrane 100, and first gas diffusion layers 121 and 121′ respectively stacked on the catalyst layers 110 and 110′, and second gas diffusion layers 120 and 120′ respectively stacked on the first gas diffusion layers 121 and 121′.

The catalyst layers 110 and 110′ function as a fuel electrode and an oxygen electrode, respectively, and each includes a catalyst and a binder therein. The catalyst layers 110 and 110′ may further include a material that may increase the electrochemical surface area of the catalyst.

The first gas diffusion layers 121 and 121′ and the second gas diffusion layers 120 and 120′ may each be formed of a material such as, for example, carbon sheet or carbon paper. The first gas diffusion layers 121 and 121′ and the second gas diffusion layers 120 and 120′ diffuse oxygen and fuel supplied through the bipolar plates 90 into the entire surfaces of the catalyst layers 110 and 110′. It is to be understood that the number and positioning of catalyst layers and diffusion layers may differ from what is shown in FIG. 9 and that other layers may be present.

The fuel cell 8 including the MEA 80 may operate at a temperature of 100 to 300° C. Fuel such as hydrogen is supplied through one of the bipolar plates 90 into a first catalyst layer, and an oxidant such as oxygen is supplied through the other bipolar plate 90 into a second catalyst layer. Then, hydrogen is oxidized into protons in the first catalyst layer, and the protons are conducted to the second catalyst layer through the electrolyte membrane 100. Then, the protons electrochemically react with oxygen in the second catalyst layer to produce water and generate electrical energy. Moreover, the hydrogen that is supplied as a fuel may be hydrogen that is produced by reforming hydrocarbons or alcohols. Oxygen supplied as an oxidant may be supplied in the form of air.

Substituents in the formulae above may be defined as follows.

Examples of the alkyl group referred to herein include, but are not limited to, a methyl group, an ethyl group, a propyl group, an isobutyl group, a sec-butyl group, a pentyl group, an iso-amyl group, and a hexyl group, wherein at least one hydrogen atom of the alkyl group may be substituted with a substituent such as a halogen atom, a C1-C20 alkyl group substituted with a halogen atom (for example, CCF₃, CHCF₂, CH₂F and CCl₃), a hydroxyl group, a nitro group, a cyano group, an amino group, an amidino group, a hydrazine, a hydrazone, a carboxyl group or a salt thereof, a sulfonic acid group or a salt thereof, a phosphoric acid or a salt thereof, a C1-C20 alkyl group, a C2-C20 alkenyl group, a C2-C20 alkynyl group, a C1-C20 heteroalkyl group, a C6-C20 aryl group, a C6-C20 arylalkyl group, a C6-C20 heteroaryl group or a C6-C20 heteroarylalkyl group.

Examples of the alkoxy group referred to herein include a methoxy group, an ethoxy group, and a propoxy group. At least one hydrogen atom in the alkoxy group may be substituted with a same substituent as described above with respect to the alkyl group.

Examples of the alkenyl group referred to herein include vinylene and allylene. At least one hydrogen atom in the alkenyl group may be substituted with a same substituent as described above with respect to the alkyl group.

An example of the alkynyl group used herein includes acetylene. At least one hydrogen atom in the alkynyl group may be substituted with a same substituent as described above with respect to the alkyl group.

The aryl group referred to herein may be used alone or in combination. In particular, the term “aryl group” refers to an aromatic system containing at least one ring. Examples of the aryl group include a phenyl group, a naphthyl group, a tetrahydronaphthyl group, and the like. At least one hydrogen atom of the aryl group may be substituted with a same substituent as described above with respect to the alkyl group.

An example of the aryloxy group referred to herein includes a phenoxy group. At least one hydrogen atom in the aryloxy group may be substituted with a same substituent as described above with respect to the alkyl group.

The term “heteroaryl group” used in the Formulae above refers to an aromatic organic compound that includes at least one heteroatom selected from among nitrogen (N), oxygen (O), phosphorous (P) and sulfur (S) and remaining ring atoms of C. At least one hydrogen atom of the heteroaryl group may be substituted with a substituent described above with respect to the alkyl group.

The term “carbon ring group” used herein refers to a cyclic group exclusively including carbon atoms, such as a cyclohexyl group. At least one hydrogen atom in the carbon ring group may be substituted with a same substituent as described above with respect to the alkyl group.

The term “heterocyclic group” used herein refers to a cyclic group including a heteroatom such as N, S, P, or O. An example of the heterocyclic group is pyridyl. At least one hydrogen atom in the heterocyclic group may be substituted with a same substituent as described above with respect to the alkyl group.

Examples of the halogen atom referred to herein include a fluorine atom, a chlorine atom, a bromine atom, and the like. The term “halogenated” used to define substituents herein means that a substituent includes a halogen atom, such as a fluorine, chlorine, or bromine atom, or includes an organic group containing a halogen atom. In this regard, an example of the organic group is a C1-C20 alkyl group.

With regard to the arylene group, the heteroarylene group, the heteroaryloxy group, the carbon ring group, the heterocyclic alkyl group, the carbocyclic alkyl group, and the heteroarylalkyl used herein, at least one hydrogen atom of these groups may be substituted with a same substituent as described above with respect to the alkyl group.

Hereinafter, one or more embodiments of the present invention will be described in detail with reference to the following examples. These examples are not intended to limit the purpose and scope of the one or more embodiments of the present invention.

### Example 1-1

### Manufacture of Bipolar Plate by Using a Mixture of BPS-a and Timrex in a Weight Ratio of 1:2 and Metal Plate

3.5 g of N,N-dimethylacetamide was added to 0.85 g of BPS-a of Formula 14 as a solvent and then stirred. The mixture was heated to 40-50° C. to prepare a BPS-a solution.

1.7 g of Timrex as conducting carbon was added to the BPS-a solution and mixed for 1 hour to obtain a slurry for forming a coating layer. Herein, BPS-a and Timrex were mixed in a weight ratio of 1:2.

The coating layer forming slurry was coated on a stainless steel plate having a thickness of 1.2 mm to a thickness of about 50 μM by using tape casting.

The metal plate coated with the coating layer forming slurry was dried in a 100° C.-oven for 4 hours to remove the solvent.

Then, the resulting metal plate was thermally treated at 250° C. to form a coating layer containing a polymer of BPS-a and Timrex on the metal plate, thereby completing the manufacture of a bipolar plate for a fuel cell.

### Example 1-2

### Manufacture of Bipolar Plate by Using a Mixture of BPS-a and Timrex in a Weight Ratio of 1:2 and Stainless Steel Plate Having Grooves of about 5 μm in Width and Depth

A bipolar plate for a fuel cell was manufactured in the same manner as in Example 1-1, except that grooves of about 5 μm in width and depth were formed in the metal plate prior to coating the coating layer forming slurry on the surface of the stainless steel plate.

Herein, the grooves of about 5 μm in width and depth were formed by sandpapering.

In the sandpapering, initially the surface of the metal plate was rubbed with a smooth sandpaper (cw-400, cw-1000 or cw-2000, available from Daesung Abrasive Co., Ltd. of Korea) about 1000 to 2000 times for about 3 to 5 minutes to remove impurities such as an oxide film, and then the surface was rubbed with a slightly rough sandpaper about 400 times for about 5 to 10 minutes to form the grooves. The surface of the metal plate was locally rubbed periodically in different directions to form grooves without any pattern extending in any direction over the entire surface of the metal plate.

### Example 1-3

### Manufacture of Bipolar Plate by Using a Mixture of BPS-a and Timrex in a Weight Ratio of 1:2 and Stainless Steel Plate Having Grooves of about 20 μm in Width and Depth

A bipolar plate for a fuel cell was manufactured in the same manner as in Example 1-1, except that grooves of about 20 μm in width and depth were formed in the metal plate prior to coating the coating layer forming slurry on the surface of the stainless steel plate.

The grooves of about 20 μm in width and depth were formed by further abrading the surface of a metal plate including grooves of about 5 μm in width and depth with a more rough sandpaper. The sandpapering with the sandpaper was performed in the same manner as when forming the grooves of about 5 μm in Example 1-2. Alternatively, a file or a rasp may be used, instead of the sandpaper. In this regard, the grooves may be formed in the same manner as when to form the grooves of 5 μm in Example 1-2.

Electric resistance characteristics of the bipolar plates of Examples 1-1 to 1-3 with respect to applied pressure were evaluated using an in-house manufactured electric resistance measuring device. The electric resistance measuring device included a pressing device for fixing a sample whose resistance was to be measured and a measurement and control unit for measuring resistance while applying current and controlling pressuring conditions. The pressing device measured resistance by using compressed nitrogen in a pressure range of about 0.03 to bout 1.57 N/mm² (0.1 bar to 5 bar).

The pressure acting on both the bipolar plate and an MEA of a sample in a measurement stack placed in the pressing device was 1.4 N/mm². Two gold-coated current collectors were placed between a pair of presses of the pressing device, with spacing blocks respectively disposed between the current collectors and the presses.

Two sheets of carbon paper were placed between the current collectors, respectively, and a sample whose resistance was to be measured was placed between the two sheets of carbon paper. Then, the resistance of the sample was measured while increasingly applying a pressure to press the measurement stack including the sample. In other words, a cross-section of the measurement stack included, from its top, a press, a spacing block, a current collector, a carbon paper, the sample, another carbon paper, another current collector, another spacing block, and another press.

The results of measuring the electric resistances of the bipolar plates are shown in FIG. 2 and Table 1.

Referring to FIG. 2, the electric resistance characteristics of the bipolar plates of Examples 1-1 to 1-3 were found to be excellent.

TABLE 1

Applied pressure (N/mm²)

| Example | 0.03 | 0.31 | 0.78 | 1.57 |
|---|---|---|---|---|
| Example 1-1 | 1563 | 134.7 | 50.4 | 20.7 |
| Example 1-2 | 338 | 30.84 | 16.79 | 11.84 |
| Example 1-3 | 964 | 48.08 | 20.15 | 12.51 |

### Example 2-1

### Manufacture of Bipolar Plate by Using a Mixture of BPS-a and Timrex in a Weight Ratio of 1:1 and Stainless Steel Plate Having Grooves of about 5 μm in Width and Depth

A bipolar plate for a fuel cell was manufactured in the same manner as in Example 1-2, except that the mixed ratio of BPS-a of Formula 14 and Timrex was varied to be 1:1 by weight.

### Example 2-2

### Manufacture of Bipolar Plate by Using a Mixture of BPS-a and Timrex in a Weight Ratio of 1:2 and Stainless Steel Plate Having Grooves of about 5 μm in Width and Depth

A bipolar plate for a fuel cell was manufactured in the same manner as in Example 2-1, except that the mixed ratio of BPS-a and Timrex was varied to be 1:2 by weight. Here, Example 2-2 is the same as Example 1-2.

### Example 2-3

### Manufacture of Bipolar Plate by Using a Mixture of BPS-a and Timrex in a Weight Ratio of 1:4 and Stainless Steel Plate Having Grooves of about 5 μm in Width and Depth

A bipolar plate for a fuel cell was manufactured in the same manner as in Example 2-1, except that the mixed ratio of BPS-a and Timrex was varied to be 1:4 by weight.

### Example 3-1

### Manufacture of Bipolar Plate by Using a Mixture of BPS-a and Vulcan Xc-72 in a Weight Ratio of 1:0.25 and Stainless Steel Plate Having Grooves of about 5 μm in Width and Depth

A bipolar plate for a fuel cell was manufactured in the same manner as in Example 2-1, except that Vulcan XC-72 was used instead of Timrex, and a mixed ratio of BPS-a and Vulcan XC-72 was 1:0.25 by weight.

### Example 3-2

### Manufacture of Bipolar Plate by Using a Mixture of BPS-a and Vulcan XC-72 in a Weight Ratio of 1:0.5 and Stainless Steel Plate Having Grooves of about 5 μm in Width and Depth

A bipolar plate for a fuel cell was manufactured in the same manner as in Example 3-1, except that the mixed ratio of BPS-a and Vulcan XC-72 was varied to be 1:0.5 by weight.

### Example 3-3

### Manufacture of Bipolar Plate by Using a Mixture of BPS-a and Vulcan XC-72 in a Weight Ratio of 1:1 and Stainless Steel Plate Having Grooves of about 5 μm in Width and Depth

A bipolar plate for a fuel cell was manufactured in the same manner as in Example 3-1, except that the mixed ratio of BPS-a and Vulcan XC-72 was varied to be 1:1 by weight.

### Example 3-4

### Manufacture of Bipolar Plate by Using a Mixture of BPS-a and Vulcan XC-72 in a Weight Ratio of 1:2 and Stainless Steel Plate Having Grooves of about 5 μm in Width and Depth

A bipolar plate for a fuel cell was manufactured in the same manner as in Example 3-1, except that the mixed ratio of BPS-a and Vulcan XC-72 was varied to be 1:2 by weight.

### Example 3-5

### Manufacture of Bipolar Plate by Using a Mixture of BPS-a and Vulcan XC-72 in a Weight Ratio of 1:4 and Stainless Steel Plate Having Grooves of about 5 μm in Width and Depth

A bipolar plate for a fuel cell was manufactured in the same manner as in Example 3-1, except that the mixed ratio of BPS-a and Vulcan XC-72 was varied to be 1:4 by weight.

### Example 4-1

### Manufacture of Bipolar Plate by Using a Mixture of BPS-a and Timrex in a Weight Ratio of 1:0.5 and Stainless Steel Plate Having Grooves of about 20 μm in Width and Depth

5.5 g of N,N-dimethylacetamide was added to 3.4 g of BPS-a of Formula 14 as a solvent and then stirred. The mixture was heated to 40-50° C. to prepare a BPS-a solution.

1.7 g of Timrex as conducting carbon was added to the BPS-a solution and mixed for 1 hour to obtain a slurry for forming a coating layer. Herein, BPS-a and Timrex were mixed in a weight ratio of 1:0.5.

The coating layer forming slurry was coated on a stainless steel plate having a thickness of 1.2 mm and grooves of about 20 μm in width and depth to a thickness of about 50 μm by using tape casting.

The stainless steel plate coated with the coating layer forming slurry was dried in a 100° C.-oven for 4 hours to remove the solvent.

Then, the resulting metal plate was thermally treated at 250° C. to form a coating layer containing a polymer of BPS-a and Timrex on the stainless steel plate, thereby completing the manufacture of a bipolar plate for a fuel cell. The coating layer had a thickness of about 5 μm.

The stainless steel plate having the grooves of about 20 μm in width and depth was prepared in the same manner as in Example 1-3.

### Example 4-2

### Manufacture of Bipolar Plate by Using a Mixture of BPS-a and Timrex in a Weight Ratio of 1:1 and Stainless Steel Plate Having Grooves of about 20 μm in Width and Depth

A bipolar plate for a fuel cell was manufactured in the same manner as in Example 4-1, except that the mixed ratio of BPS-a and Timrex was varied to be 1:1 by weight.

### Example 4-3

### Manufacture of Bipolar Plate by Using a Mixture of BPS-a and Timrex in a Weight Ratio of 1:2 and Stainless Steel Plate Having Grooves of about 20 μm in Width and Depth

A bipolar plate for a fuel cell was manufactured in the same manner as in Example 4-1, except that the mixed ratio of BPS-a and Timrex was varied to be 1:2 by weight.

### Example 4-4

### Manufacture of Bipolar Plate by Using a Mixture of BPS-a and Timrex in a Weight Ratio of 1:4 and Stainless Steel Plate Having Grooves of about 20 μm in Width and Depth

A bipolar plate for a fuel cell was manufactured in the same manner as in Example 4-1, except that the mixed ratio of BPS-a and Timrex was varied to be 1:4 by weight.

### Comparative Example 1

### Manufacture of Bipolar Plate by Using a Mixture of Phenol Resin and Vulcan XC-72 in a Weight Ratio of 1:1

A bipolar plate for a fuel cell was manufactured in the same manner as in Example 3-3, except that phenol resin was used instead of BPS-a.

### Comparative Example 2

### Manufacture of Bipolar Plate by Using a Mixture of Phenol Resin and Vulcan XC-72 in a Weight Ratio of 1:2

A bipolar plate for a fuel cell was manufactured in the same manner as in Example 3-4, except that phenol resin was used instead of BPS-a.

### Comparative Example 3

### Manufacture of Bipolar Plate by Using a Mixture of Phenol Resin and Vulcan XC-72 in a Weight Ratio of 1:0.5

A bipolar plate for a fuel cell was manufactured in the same manner as in Example 3-2, except that phenol resin was used instead of BPS-a.

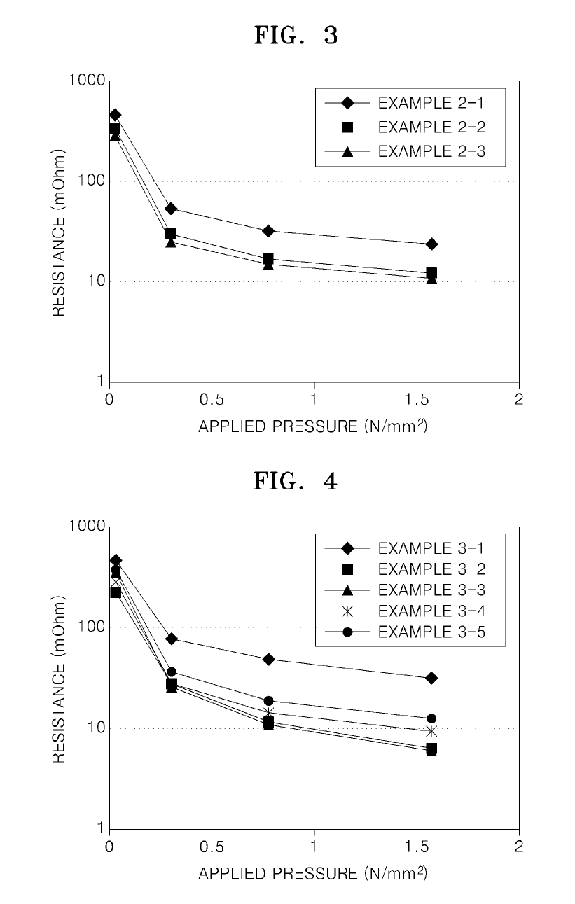

Resistance characteristics of the bipolar plates for a fuel cell manufactured in Examples 2-1 through 2-3 at different applied pressures were measured. The results are shown in FIG. 3 and Table 2.

TABLE 2

| | |
|---|---|
| BPS-a:Timrex | Applied pressure (N/mm²) |

| (weight ratio) | 0.03 | 0.31 | 0.78 | 1.57 |
|---|---|---|---|---|
| 1:1 | 468 | 53.895 | 32.255 | 24.116 |
| 1:2 | 338 | 30.845 | 16.7925 | 11.84 |
| 1:4 | 297 | 26.135 | 15.155 | 11.21 |

Referring to Table 2 and FIG. 3, the resistances of the bipolar plates tend to decrease at higher pressures. Carbon paper basically has a porous structure. However, the porosity of the carbon paper becomes less as a higher pressure is applied, so that the carbon paper may have a larger surface area with adjacent surfaces. As a result, the electric resistance of the bipolar plate is decreased. A pressure acting on the bipolar plate and an MEA of a sample in a measurement stack placed in the pressing device was about 1.4 N/mm².

In addition, when the mixed ratio of BPS-a to the conducting material (i.e., Timrex) was in the range of 1:2 to 1:4, the resistance characteristics of the bipolar plate were excellent without a weakening of the binding force of the coating layer to the surface of the metal plate.

Resistance characteristics of the bipolar plates for a fuel cell manufactured according to Examples 3-1 through 3-5 were measured at different applied pressures. The results are shown in FIG. 4 and Table 3.

TABLE 3

| | |
|---|---|
| BPS-a:Vulcan | |
| XC-72 | Applied pressure (N/mm²) |

| (weight ratio) | 0.03 | 0.31 | 0.78 | 1.57 |
|---|---|---|---|---|
| 1:0.25 | 476 | 80.5 | 49.95 | 31.81 |
| 1:0.5 | 228 | 27.82 | 11.61 | 6.34 |
| 1:1 | 363.5 | 26.275 | 11.175 | 6.185 |
| 1:2 | 294 | 28.49 | 14.51 | 9.59 |
| 1:4 | 387 | 37.02 | 19.04 | 12.67 |

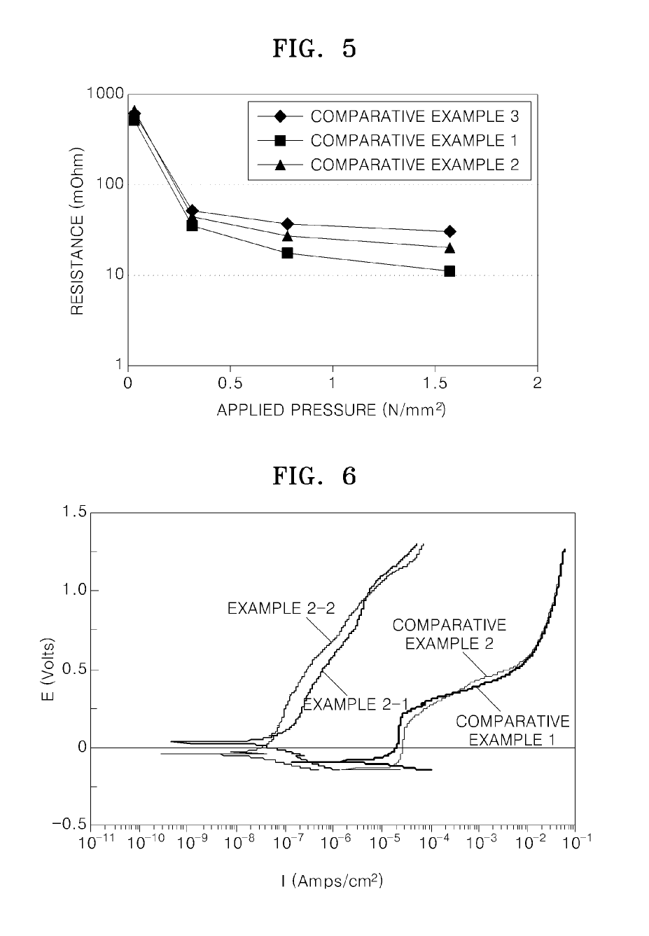

Resistance characteristics of the bipolar plates for a fuel cell manufactured according to Comparative Examples 1 through 3 were measured at different applied pressures. The results are shown in FIG. 5 and Table 4.

TABLE 4

| | |
|---|---|
| Phenol resin:Vulcan | |
| XC-72 | Applied pressure (N/mm²) |

| (weight ratio) | 0.03 | 0.31 | 0.78 | 1.57 |
|---|---|---|---|---|
| 1:0.5 | 626.5 | 53.355 | 37.58 | 30.59 |
| 1:1 | 520.5 | 35.4 | 17.575 | 11.12 |
| 1:2 | 674 | 43.95 | 27.25 | 20.65 |

Referring to FIG. 5 and Table 4, the bipolar plates of Comparative Examples 1 through 3 had poorer resistance characteristics as compared to those of Examples 3-3, 3-4 and 3-2, respectively.

The resistance to acid of each of the bipolar plates of Examples 2-1 and 2-2 and Comparative Examples 1 and 2 was evaluated.

The resistance to acid was evaluated from the corrosion characteristics of the surface of the metal plate coated with the polymer of the benzoxazine-based compound and the conducting material by using an electrochemical method. A potentiodynamic method was used at a voltage of −0.15V to 1.3V at a scan rate of 5 mV/sec to measure the resistance to acid. An Ag/AgCl electrode was used as a reference electrode.

The results of the test of resistance to acid are shown in FIG. 6.

Referring to FIG. 6, the corrosion currents for the bipolar plates of Examples 2-1 and 2-2 were found to be relatively lower than those for the bipolar plates of Comparative Examples 1 and 2.

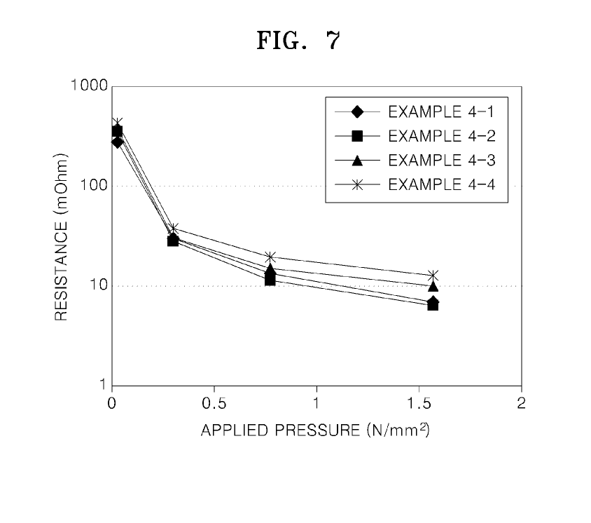

Resistance characteristics of the bipolar plates of Examples 4-1 to 4-4 for use in fuel cells were measured at different pressures. The results are shown in FIG. 7 and Table 5.

TABLE 5

Applied pressure (N/mm²)

| BPS-a:Timrex | 0.03 | 0.31 | 0.78 | 1.57 |
|---|---|---|---|---|
| 1:0.5 | 286 | 29.12 | 12.88 | 6.79 |
| 1:1 | 354 | 26.98 | 11.32 | 6.21 |
| 1:2 | 388 | 29.47 | 14.82 | 9.87 |
| 1:4 | 434 | 36.42 | 18.89 | 12.42 |

As described above, according to the one or more of the above embodiments of the present invention, a bipolar plate for a fuel cell that has excellent resistance to acid and electrical conductivity in a wide range of temperatures may be manufactured at lower costs by forming a coating layer containing a polymer of an oxazine compound, particularly a benzoxazine-based compound that is resistant to acid on a surface of a metal plate.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A bipolar plate for a fuel cell, comprising:
a metal plate; and
a coating layer disposed on a surface of the metal plate, the coating layer including a polymer of an oxazine-based compound and a conducting material,
wherein the oxazine-based compound comprises at least one compound selected from among the compounds represented by Formulae 1, 2, 3, 4, 5, 5A and 6 below: 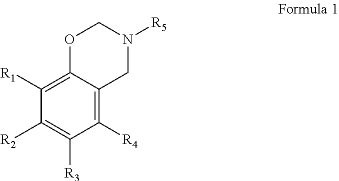
wherein, in Formula 1, R₁ through R₄ are each independently a hydrogen atom, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₂-C₂₀ heteroaryl group, a substituted or unsubstituted C₂-C₂₀ heteroaryloxy group, a substituted or unsubstituted C₄-C₂₀ carbon ring group, a substituted or unsubstituted C₄-C₂₀-carbocyclic alkyl group, a substituted or unsubstituted C₂-C₂₀ heterocyclic group, a halogen atom, a hydroxyl group, or a cyano group; and
R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group, 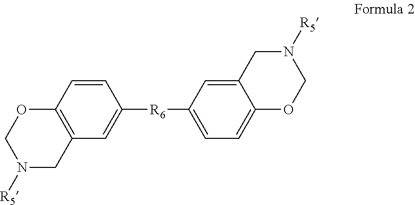
in Formula 2, R₅′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
R₆ is selected from the group consisting of a substituted or unsubstituted C₁-C₂₀ alkylene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₂-C₂₀ heteroarylene group, —C(═O)—, and —SO₂—, 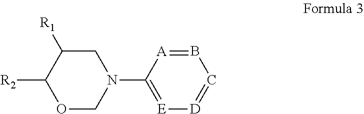
in Formula 3, A, B, C, D and E are all carbon; or one or two of A, B, C, D and E is nitrogen and the others are carbon; and
R₁ and R₂ are linked to form a ring, wherein the ring is a C₆-C₁₀ carbon ring group, a C₃-C₁₀ heteroaryl group, a fused C₃-C₁₀ heteroaryl group, a C₃-C₁₀ heterocyclic group or a fused C₃-C₁₀ heterocyclic group, 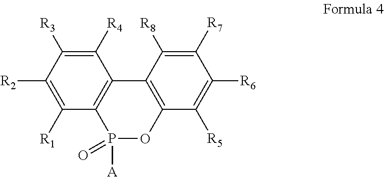
in Formula 4, A is a substituted or unsubstituted C₁-C₂₀ heterocyclic group, a substituted or unsubstituted C₄-C₂₀ cycloalkyl group, or a substituted or unsubstituted C₁-C₂₀ alkyl group; and
R₁ through R₈ are each independently a hydrogen atom, a C₁-C₂₀ alkyl group, a C₁-C₂₀ alkoxy group, a C₆-C₂₀ aryl group, a C₆-C₂₀ aryloxy group, a C₁-C₂₀ heteroaryl group, a C₁-C₂₀ heteroaryloxy group, a C₄-C₂₀ cycloalkyl group, a C₁-C₂₀ heterocyclic group, a halogen atom, a cyano group, or a hydroxyl group, wherein at least one of A and R₁ through R₈ comprises a benzoxazine group, 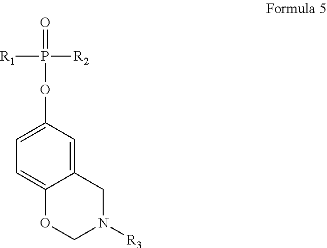
in Formula 5, R₁ and R₂ are each independently a C₁-C₂₀ alkyl group, a C₁-C₂₀ alkoxy group, a C₆-C₂₀ aryl group, a C₆-C₂₀ aryloxy group or a group represented by Formula 5A below, 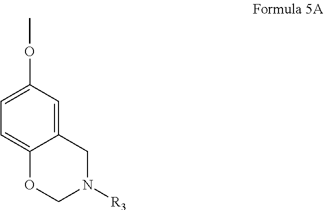
in Formulae 5 and 5A, R₃ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group. 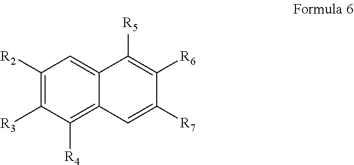
in Formula 6, at least two adjacent groups selected from among R₂, R₃ and R₄ are linked to form a group represented by Formula 2A below, and the non-selected, remaining group is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group; and
at least two adjacent groups selected from among R₅, R₆ and R₇ are linked to form the group represented by Formula 2A below, and the non-selected, remaining group is a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group, 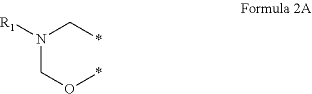
in Formula 2A, R₁ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
* denotes the sites at which the at least two adjacent groups selected from among R₂, R₃ and R₄ of Formula 6 and the at least two adjacent groups selected from among R₅, R₆ and R₇ of Formula 6 are linked, respectively.

2. The bipolar plate of claim 1, wherein the conducting material comprises at least one material selected from the group consisting of carbon black, graphite and carbon nanotubes.

3. The bipolar plate of claim 1, wherein the amount of the conducting material is in the range of about 0.25 parts to about 10 parts by weight based on 1 part by weight of the polymer of the oxazine-based compound.

4. The bipolar plate of claim 1, wherein the metal plate comprises a stainless steel plate, an aluminum plate or a carbon steel plate.

5. The bipolar plate of claim 1, wherein the oxazine-based compound comprises at least one compound selected from the compounds represented by Formulae 7 through 14 below:

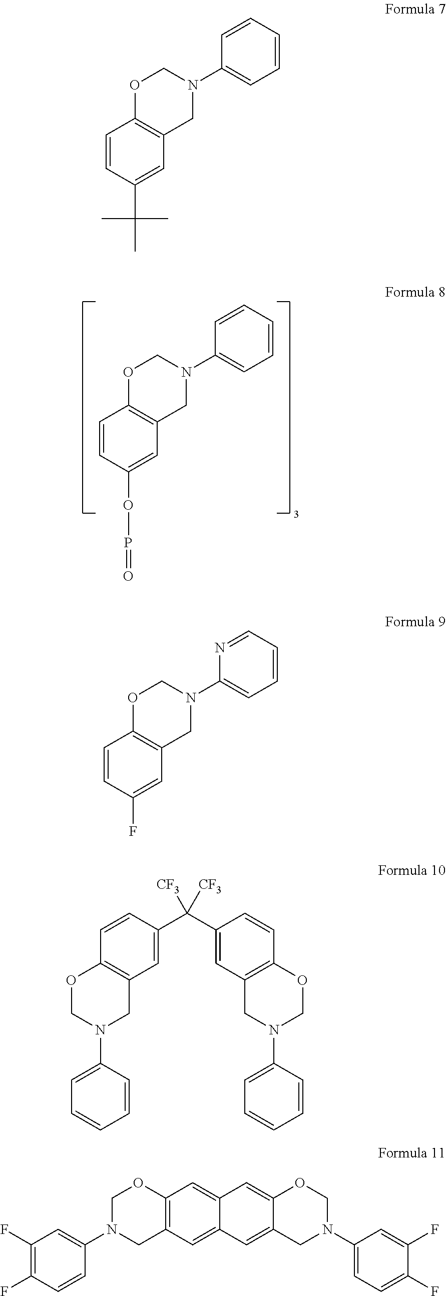

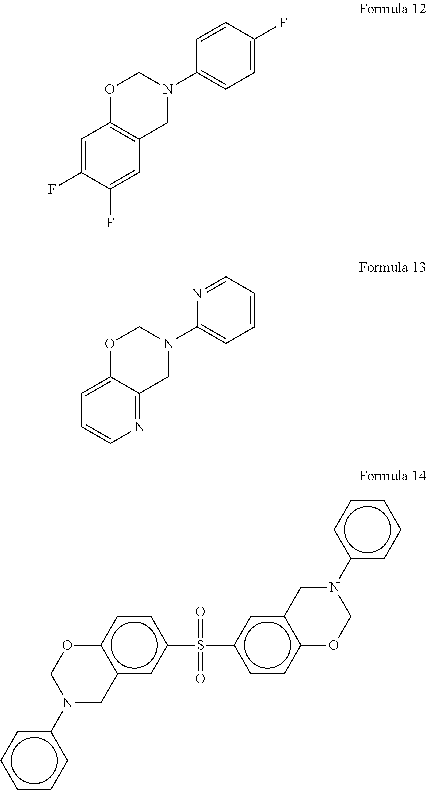

6. The bipolar plate of claim 1, wherein the surface of the metal plate includes a groove.

7. A method of manufacturing a bipolar plate for a fuel cell, the method comprising:
coating a surface of a metal plate with a coating layer forming composition comprising at least one oxazine-based compound selected from among compounds represented by Formulae 1, 2, 3, 4, 5, 5A and 6 below, a conducting material, and a solvent; and
thermally treating the metal plate coated with the coating layer forming composition. 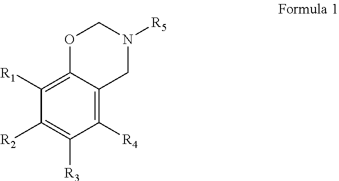
wherein in Formula 1, R₁ through R₄ are each independently a hydrogen atom, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₂-C₂₀ heteroaryl group, a substituted or unsubstituted C₂-C₂₀ heteroaryloxy group, a substituted or unsubstituted C₄-C₂₀ carbon ring group, a substituted or unsubstituted C₄-C₂₀ carbocyclic alkyl group, a substituted or unsubstituted C₂-C₂₀ heterocyclic group, a halogen atom, a hydroxyl group, or a cyano group; and
R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group, 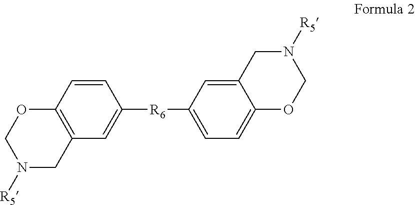
in Formula 2, R₅′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
R₆ is selected from the group consisting of a substituted or unsubstituted C₁-C₂₀ alkylene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₂-C₂₀ heteroarylene group, —C(═O)—, and —SO₂—, 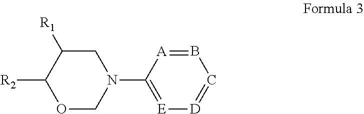
in Formula 3, A, B, C, D and E are all carbon; or one or two of A, B, C, D and E is nitrogen and the others are carbon; and
R₁ and R₂ are linked to form a ring, wherein the ring is a C₆-C₁₀ cycloalkyl group, a C₃-C₁₀ heteroaryl group, a fused C₃-C₁₀ heteroaryl group, a C₃-C₁₀ heterocyclic group or a fused C₃-C₁₀ heterocyclic group, 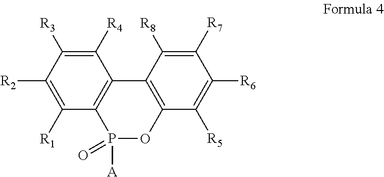
in Formula 4, A is a substituted or unsubstituted C₁-C₂₀ heterocyclic group, a substituted or unsubstituted C₄-C₂₀ cycloalkyl group, or a substituted or unsubstituted C₁-C₂₀ alkyl group;
R₁ through R₈ are each independently a hydrogen atom, a C₁-C₂₀ alkyl group, a C₁-C₂₀ alkoxy group, a C₆-C₂₀ aryl group, a C₆-C₂₀ aryloxy group, a C₁-C₂₀ heteroaryl group, a C₁-C₂₀ heteroaryloxy group, a C₄-C₂₀ cycloalkyl group, a C₁-C₂₀ heterocyclic group, a halogen atom, a cyano group, or a hydroxyl group, wherein at least one of A and R₁, through R₈ comprises a benzoxazine group, 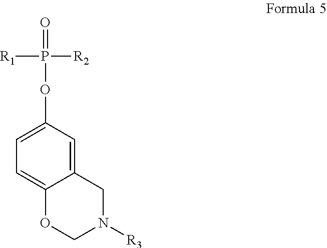
in Formula 5, R₁ and R₂ are each independently a C₁-C₂₀ alkyl group, a C₁-C₂₀ alkoxy group, a C₆-C₂₀ aryl group, a C₆-C₂₀ aryloxy group or a group represented by Formula 5A below, 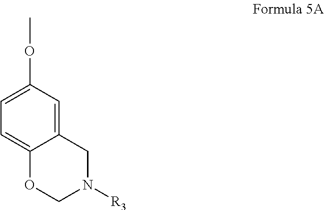
in Formulae 5 and 5A, R₃ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group, 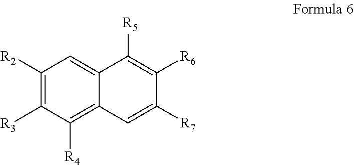
in Formula 6, at least two adjacent groups selected from among R₂, R₃ and R₄ are linked to form a group represented by Formula 2A below, and the non-selected, remaining group is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group; and
at least two adjacent groups selected from among R₅, R₆ and R₇ are linked to form the group represented by Formula 2A below, and the non-selected, remaining group is a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group, 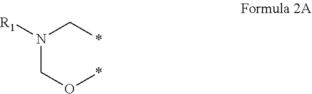
in Formula 2A, R₁ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
* denotes the sites at which the at least two adjacent groups selected from among R₂, R₃ and R₄ of Formula 6 and the at least two adjacent groups selected from among R₅, R₆ and R₇ of Formula 6 are linked, respectively.

8. The method of claim 7, wherein the amount of the conducting material is in the range of about 0.25 parts to about 10 parts by weight based on 1 parts by weight of the oxazine-based compound.

9. The method of claim 7, further comprising processing the surface of the metal plate before the coating of the surface of the metal plate with the coating layer forming composition.

10. The method of claim 7, wherein the processing of the surface of the metal plate comprises at least one process selected from the group consisting of etching, brushing, sandpapering and blasting.

11. The method of claim 7, wherein the thermally treating is performed at a temperature of about 150 to about 280° C.

12. A fuel cell comprising the bipolar plate according to claim 1.

13. A fuel cell comprising the bipolar plate according to claim 2.

14. A fuel cell comprising the bipolar plate according to claim 3.

15. A fuel cell comprising the bipolar plate according to claim 4.

16. A fuel cell comprising the bipolar plate according to claim 5.

17. A fuel cell comprising the bipolar plate according to claim 6.
